(19) United States
(12) Patent Application Publication
(10) Pub. No.: US 2024/0212475 A1
(43) Pub. Date: Jun. 27, 2024

(54) DETECTING A MALFUNCTION ASSOCIATED WITH AN IMPULSE LINE

(71) Applicant: CANADIAN NATURAL RESOURCES LIMITED, Calgary (CA)

(72) Inventors: Vahid VAJIHINEJAD, Calgary (CA); Sachin PUPNEJA, Calgary (CA)

(21) Appl. No.: 18/393,559

(22) Filed: Dec. 21, 2023

Related U.S. Application Data
(60) Provisional application No. 63/434,799, filed on Dec. 22, 2022.

(51) Int. Cl. G08B 21/18

(52) U.S. Cl. CPC G08B 21/187; G08B 21/185

(57) ABSTRACT

Malfunctions associated with impulse lines can have signification implications, such as process upset, plant tripping, product loss and threat to personnel. In some examples of the disclosure, measurements performed on contents of the first impulse line may be used in combination with measurements performed on contents of a second impulse line to detect whether a malfunction associated with the first impulse line has occurred. This may allow for detecting a malfunction associated with the first impulse line without requiring specialist hardware.

### CROSS-REFERENCE TO RELATED APPLICATION

This application claims the benefit of U.S. Provisional Patent Application Ser. No. 63/434,799 filed on Dec. 22, 2022. The contents of the aforementioned application are incorporated by reference herein.

### FIELD

The present disclosure relates to impulse lines and, in particular, to detecting a malfunction associated with an impulse line.

### BACKGROUND

Impulse lines may be connected to a pipe or vessel for use in for monitoring the properties of its contents. An impulse line may typically include a small diameter tube or pipe for receiving material. The impulse line may be provided with a sensor for measuring a property of the material and a transmitter for transmitting the measured property to a control system. However, in cold environments frozen fluid or gas condensates can plug the tube of the impulse line, which risks causing the transmitter to send an incorrect signal or reading to the control system. This can result in a process upset or a plant tripping. In extreme cases, a frozen impulse line can rupture. Process fluid leaks can result in product loss, energy loss, measurement errors, and can be a serious threat to personnel safety and the environment.

### SUMMARY

In one aspect, a method for detecting a malfunction associated with a first impulse line is provided. The first impulse line may be operatively connected to a system. The method may involve obtaining a first correlation between first measurements and second measurements. The first measurements may have been performed on contents of the first impulse line in a first time window. The second measurements may have been performed on contents of a second impulse line in a second time window that overlaps the first time window. The second impulse line may be operatively connected to the system. The method may also involve obtaining a first amount of variation of the first measurements in the first time window and inputting the first amount of variation and the first correlation to a model to detect whether a malfunction associated with the first impulse line has occurred. The model may have been developed using a machine-learning process. The method may also involve causing an alert indicating that the malfunction has been detected responsive to detecting that the malfunction has occurred at the first impulse line.

The model may have been developed by inputting, to the machine-learning process, a second amount of variation of third measurements in a third time window and a second correlation between the third measurements and fourth measurements. The third measurements may have been performed on contents of the first impulse line. The fourth measurements may have been performed in a fourth time window that overlaps with the third time window. The fourth measurements may have been performed on contents of the second impulse line.

The model may have been developed by inputting, to the machine-learning process: a label associated with the second amount of variation and the second correlation. The label may have indicated whether a malfunction associated with the first impulse line occurred in the third time window. The label may have indicated that the malfunction associated with the first impulse line occurred in the third time window.

The first time window may be a sliding time window. The second time window may be a sliding time window. The first time window may have a duration of between 60-100 minutes. The second time window may have a duration of between 60-100 minutes. The first and second time window may be the same.

The method may also involve receiving the first measurements from a first transmitter associated with the first impulse line.

The method may also involve determining the first amount of variation of the first measurements.

The method may also involve receiving the second measurements from a second transmitter associated with the second impulse line.

Obtaining the first correlation between the first measurements and the second measurements may involve determining the first correlation based on the first measurements and the second measurements.

The first amount of variation of the first measurements in the first time window may include a standard deviation of the first measurements in the first time window.

The first measurements may include measurements of a first property performed on the contents of the first impulse line. The second measurements may include measurements of a second property performed on the contents of the second impulse line. The first property and the second property may be different.

The first property may include pressure. The first property may include level. The first property may include flow. The second property may include pressure. The second property may include level. The second property may include flow.

The malfunction may include clogging of the first impulse line. The malfunction may include clogging of the first impulse line due to freezing of the first impulse line.

Causing the alert may cause the alert to be output at a user interface associated with a controller of the system.

In another aspect, a processor-readable storage medium is also provided. The processor-readable storage medium stores processor-executable instructions which, when executed by at least one processor of an apparatus, cause the apparatus to perform the method described above. An apparatus configured to perform the method described above is also provided.

In another aspect, a method is provided. The method is for detecting a malfunction associated with a first impulse line operatively connected to a system. The method involves obtaining a predicted measurement for the first impulse line at a first time. The predicted measurement may be based on a first measurement and a second measurement. The first measurement may have been performed on contents of the first impulse line at a second time before the first time. The second measurement may have been performed on contents of a second impulse line. The second impulse line may be operatively connected to the system. The method may also involve comparing the predicted measurement to a third measurement performed using the first impulse line at the first time to detect whether a malfunction associated with the first impulse line has occurred. The method may also involve, responsive to detecting that the malfunction has occurred at the first impulse line, causing an alert indicating that the malfunction has been detected.

The second measurement may be performed on contents of the second impulse line at the first time.

Obtaining the predicted measurement may involve receiving the first measurement, receiving the second measurement, and inputting the first and second measurements to a model to obtain the predicted measurement for the first impulse line at the first time. The model may have been developed using a machine-learning process.

The model may have been developed by inputting, to the machine-learning process: fourth measurements performed on contents of the first impulse line, and fifth measurements performed on contents of the second impulse line.

The fourth measurements may have been indicative of an operational range of the first impulse line. The fifth measurements may have been indicative of an operational range of the first impulse line.

Comparing the predicted measurement to the third measurement to detect whether a malfunction associated with the first impulse line has occurred may involve, responsive to a difference between the predicted measurement and the third measurement satisfying a threshold, detecting that the malfunction has occurred.

The first measurement may include a measurement of a first property performed on the contents of the first impulse line. The second measurement may include a measurement of a second property performed on the contents of the second impulse line. The first property and the second property may be different.

The first property may include pressure. The first property may include level. The first property may include flow. The second property may include pressure. The second property may include level. The second property may include flow.

The malfunction may include clogging of the first impulse line. The malfunction may include clogging of the first impulse line due to freezing of the first impulse line.

Causing the alert may cause the alert to be output at a user interface associated with a controller of the system.

In another aspect, a processor-readable storage medium is provided. The processor-readable storage medium stores processor-executable instructions which, when executed by at least one processor of an apparatus, cause the apparatus to perform the method described above. An apparatus configured to perform the method described above is also provided.

In another aspect, a method is provided. The method is for detecting a malfunction associated with a first impulse line operatively connected to a system. The method may involve obtaining a first amount of variation in first measurements of a property of contents of the first impulse line in a first time window, and obtaining a second amount of variation in second measurements of the property of contents of a second impulse line in a second time window. The second impulse line may be operatively connected to the system to provide redundancy for the first impulse line. The first and second time window may overlap. The method may also involve comparing a difference between the first amount of variation and the second amount of variation to a threshold to detect whether a malfunction associated with the first impulse line has occurred, and, responsive to detecting that the malfunction associated with the first impulse line has occurred, causing an alert indicating that the malfunction has been detected.

The first amount of variation may include a standard deviation of the first measurements. The second amount of variation may include a standard deviation of the second measurements.

The first and second time window may be the same. The first time window may be a sliding time window. The second time window may be a sliding time window.

The property may include pressure. The property may include level. The property may include flow.

The malfunction may include clogging of the first impulse line. The malfunction may include clogging of the first impulse line due to freezing of the first impulse line.

Causing the alert may cause the alert to be output at a user interface associated with a controller of the system.

In another aspect, a processor-readable storage medium is provided. The processor-readable storage medium stores processor-executable instructions which, when executed by at least one processor of an apparatus, cause the apparatus to perform the method described above. An apparatus configured to perform the method described above is also provided.

In another aspect, an apparatus is provided. The apparatus is for detecting a malfunction associated with first impulse line operatively connected to a system. The apparatus includes at least one processor and a non-transitory computer-readable storage medium. The non-transitory computer-readable storage medium stores instructions which, when executed by the at least one processor, may cause the apparatus to obtain a first correlation between first measurements and second measurements, in which the first measurements are performed on contents of the first impulse line in a first time window and the second measurements are performed on contents of a second impulse line in a second time window that overlaps the first time window. The second impulse line may be operatively connected to the system. The apparatus may be further caused to obtain a first amount of variation of the first measurements in the first time window and input the first amount of variation and the first correlation to a model to detect whether a malfunction associated with the first impulse line has occurred. The model may have been developed using a machine-learning process. The apparatus may be further caused to, responsive to detecting that the malfunction has occurred at the first impulse line, cause an alert indicating that the malfunction has been detected.

The model may have been developed by inputting, to the machine-learning process: a second amount of variation of third measurements in a third time window and a second correlation between the third measurements and fourth measurements in a fourth time window that overlaps with the third time window. The third measurements may have been performed on contents of the first impulse line. The fourth measurements may have been performed on contents of the second impulse line.

The model may have been developed by inputting, to the machine-learning process: a label associated with the second amount of variation and the second correlation. The label may have indicated whether a malfunction associated with the first impulse line has occurred in the third time window. The label may have indicated that the malfunction associated with the first impulse line occurred in the third time window.

The first time window may be a sliding time window. The second time window may be a sliding time window. The first time window may have a duration of between 60-100 minutes. The second time window may have a duration of between 60-100 minutes. The first time window and the second time window may be the same.

The apparatus may be further caused to receive the first measurements from a first transmitter associated with the first impulse line.

The apparatus may be further caused to determine the first amount of variation of the first measurements.

The apparatus may be further caused to receive the second measurements from a second transmitter associated with the second impulse line.

The apparatus may be further caused to obtain the first correlation between the first measurements and the second measurements by determining the first correlation based on the first measurements and the second measurements.

The first amount of variation of the first measurements in the first time window may include a standard deviation of the first measurements in the first time window.

The first measurements may include measurements of a first property performed on the contents of the first impulse line. The second measurements may include measurements of a second property performed on the contents of the second impulse line. The first property and the second property may be different.

The first property may include pressure. The first property may include level. The first property may include flow. The second property may include pressure. The second property may include level. The second property may include flow.

The malfunction may include clogging of the first impulse line. The malfunction may include clogging of the first impulse line due to freezing of the first impulse line.

The apparatus may be caused to cause the alert by causing the alert to be output at a user interface associated with a controller of the system.

In another aspect, an apparatus is provided. The apparatus is for detecting a malfunction associated with first impulse line operatively connected to a system. The apparatus includes at least one processor and a non-transitory computer-readable storage medium. The non-transitory computer-readable storage medium stores instructions which, when executed by the at least one processor, may cause the apparatus to: obtain a predicted measurement for the first impulse line at a first time. The predicted measurement may be based on a first measurement and a second measurement. The first measurement may have been performed on contents of the first impulse line at a second time before the first time. The second measurement may have been performed on contents of a second impulse line. The second impulse line may be operatively connected to the system. The apparatus may be further caused to compare the predicted measurement to a third measurement performed using the first impulse line at the first time to detect whether a malfunction associated with the first impulse line has occurred and, responsive to detecting that the malfunction has occurred at the first impulse line, cause an alert indicating that the malfunction has been detected.

The second measurement may be performed on contents of the second impulse line at the first time.

The apparatus may be caused to obtain the predicted measurement by receiving the first measurement, receiving the second measurement, and inputting the first and second measurements to a model to obtain the predicted measurement for the first impulse line at the first time.

The model may have been developed using a machine-learning process. The model may have been developed by inputting, to the machine-learning process: fourth measurements performed on contents of the first impulse line, and fifth measurements performed on contents of the second impulse line. The fourth measurements may be indicative of an operational range of the first impulse line. The fifth measurements may be indicative of an operational range of the first impulse line.

The apparatus may be caused to compare the predicted measurement to the third measurement to detect whether a malfunction associated with the first impulse line has occurred by, responsive to a difference between the predicted measurement and the third measurement satisfying a threshold, detecting that the malfunction has occurred.

The first measurement may include a measurement of a first property performed on the contents of the first impulse line. The second measurement may include a measurement of a second property performed on the contents of the second impulse line. The first property and the second property may be different.

The first property may include pressure. The first property may include level. The first property may include flow. The second property may include pressure. The second property may include level. The second property may include flow.

The malfunction may include clogging of the first impulse line. The malfunction may include clogging of the first impulse line due to freezing of the first impulse line.

The apparatus may be caused to cause the alert by causing the alert to be output at a user interface associated with a controller of the system.

In another aspect, an apparatus is provided. The apparatus is for detecting a malfunction associated with first impulse line operatively connected to a system. The apparatus includes at least one processor, and a non-transitory computer-readable storage medium. The computer-readable storage medium stores instructions which, when executed by the at least one processor, may cause the apparatus to obtain a first amount of variation in first measurements of a property of contents of the first impulse line in a first time window, and obtain a second amount of variation in second measurements of the property of contents of a second impulse line in a second time window. The second impulse line may be operatively connected to the system to provide redundancy for the first impulse line. The first and second time window may overlap. The apparatus may be further caused to compare a difference between the first amount of variation and the second amount of variation to a threshold to detect whether a malfunction associated with the first impulse line has occurred and, responsive to detecting that the malfunction associated with the first impulse line has occurred, cause an alert indicating that the malfunction has been detected.

The first amount of variation may include a standard deviation of the first measurements. The second amount of variation may include a standard deviation of the second measurements.

The first and second time window may be the same. The first time window may be a sliding time window. The second time window may be a sliding time window.

The property may include pressure. The property may include level. The property may include flow.

The malfunction may include clogging of the first impulse line. The malfunction may include clogging of the first impulse line due to freezing of the first impulse line.

The apparatus may be caused to cause the alert by causing the alert to be output at a user interface associated with a controller of the system.

### BRIEF DESCRIPTION OF THE DRAWINGS

Embodiments will be described, by way of example only, with reference to the accompanying drawings in which:

FIG. 1 illustrates an arrangement according to embodiments of the disclosure;

FIGS. 2-4 are flowcharts of methods according to embodiments of the disclosure;

FIGS. 5 and 6 are examples of alerts output at a user interface according to embodiments of the disclosure; and

FIG. 7 is a flowchart of a method according to embodiments of the disclosure.

### DETAILED DESCRIPTION

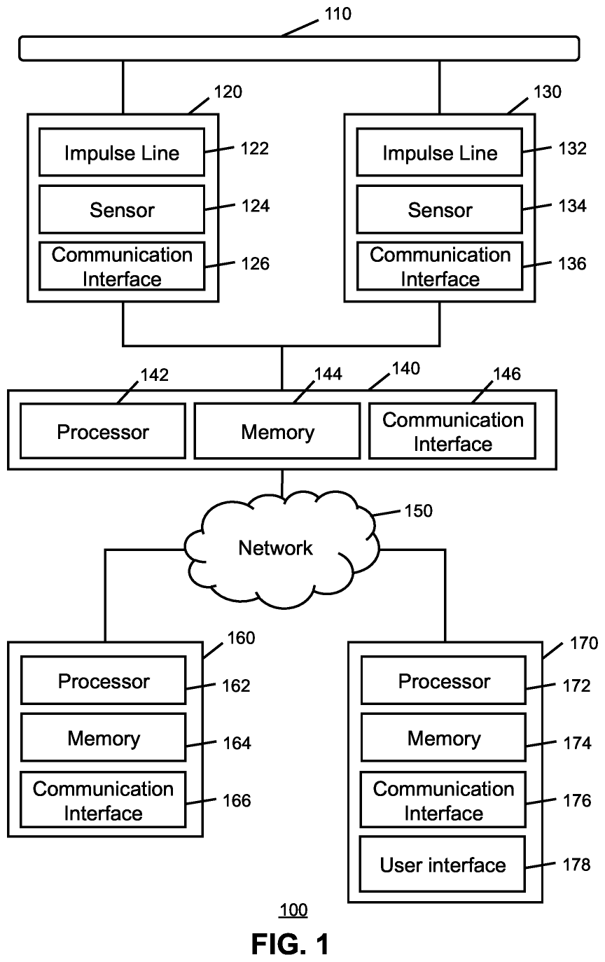

FIG. 1 illustrates an arrangement 100 according to embodiments of the disclosure. The arrangement comprises a system 110, a first impulse line device 120, a second impulse line device 130, a database 140, a network 150, a computing device 160 and a user device 170.

The system 110 may comprise one or more vessels, such as a pipe or a tube, through which material can flow. The system 110 may comprise one or more pipes. The one or more pipes may be for transporting material (e.g. carrying material from one place to another). In some examples, the system 110 may comprise a single pipe. The system 110 may additionally comprise one or more apparatus for processing material. For example, the system 110 may comprise one or more pipes connected to an apparatus to provide material to the apparatus for processing. The system 110 may further comprise one or more pipes to receive the processed material from the apparatus. It will be appreciated that there are many different ways in which a material may be processed, depending on the material and the desired result of the process. Processing may include, for example, one or more of: distilling, cracking, filtering, reforming, dimerization, treating, stripping, cooling, or any other suitable way of processing the material.

The material may be any material that can flow (e.g. any flowable material). The material may comprise a fluid such as a liquid or a gas. In some examples, the material may comprise a suspension, such as a fluidized solid or aerosol. The fluidized solid may comprise a slurry (e.g. solid particles suspended in a liquid). The aerosol may comprise liquid and/or solid particles suspended in a gas. In particular examples, the material may comprise an oil and/or natural gas product. An oil product may be a product made using (e.g. derived from or extracted from) oil. An oil product may be made using one or more other components in additional to oil. Oil in this context may refer to petroleum or crude oil. A natural gas product may be a product made using (e.g. derived from or extracted from) natural gas. A gas product may be made using one or more other components in additional to gas.

The first impulse line device 120 comprises a first impulse line 122, a first sensor 124 and a first communication interface 126.

The first impulse line 122 may comprise a vessel, such as a pipe or a tube, for receiving material from the system 110. In some examples, the first impulse line 122 may comprise a first pipe having a narrower diameter (e.g. a smaller gauge) than a second pipe of the system 110 to which it is connected. The first impulse line 122 is operatively connected to the system 110. The first impulse line 122 may thus be connected to the system 110 in such a manner to allow material to flow from the system 110 to the first impulse line 122. The first impulse line 122 may be described as being fluidly connected, or in fluid connection with, the system 110.

The first impulse line 122 may be connected to the system 110 via one or more valves (not illustrated). The one or more valves may be actuatable (e.g. openable) to cause the first impulse line 122 to be fluidly connected the system 110 when it was previously fluidly disconnected. The one or more valves may be actuatable (e.g. closeable) to cause the first impulse line 122 to be fluidly disconnected the system 110 when it was previously fluidly connected. Alternatively, the first impulse line 122 may be connected to the system 110 without any intervening valves.

The first sensor 124 is for measuring a property of a contents of the first impulse line 122. Material may flow from the system 110 into the first impulse line 122, where it can be measured by the first sensor 124. The first impulse line 122 may thus effectively connect a point in the system 110 at which a property is to be measured with the first sensor 124 for measuring that property. The first sensor 124 may thus be described as being operable to or configured for measuring the property of the contents of the first impulse line 122. The property may be any property of a flowable material that is measurable with a sensor 124. In some examples, the property may include one of more of: pressure, level and flow. The first sensor 124 may comprise one or more of: a pressure sensor, a level sensor and a flowmeter. A single first sensor 124 is illustrated in FIG. 1, but in general the first impulse line device 120 may comprise one or more first sensors 124. The one or more first sensors 124 may be operable to measure the same property or respective different properties. For example, the first impulse line device 120 may comprise two pressure sensors such that one pressure sensor can provide redundancy if the other pressure sensor malfunctions. In another example, the first impulse line device 120 may comprise a pressure sensor and a level sensor, in which the pressure sensor is operable to measure a pressure of the contents of the first impulse line 122 and the level sensor is operable to measure the level of the contents of the first impulse line 122.

The first communication interface 126 is for communicating with one or more other apparatus (e.g. with the database 140, the computing device 160 and/or the user device 170). The structure of the communication interface 126 may depend on how the first impulse line device 120 interfaces with the one or more other apparatus. The communication interface 126 may comprise a wireless communication interface. For example, the communication interface 126 may comprise a transmitter with an antenna to send wireless transmissions and/or a receiver for receiving wireless transmissions. The transmitter and the receiver may be connected to the same antenna.

The transmitter and the receiver may be integrated (e.g. in a transceiver). The transmitter may comprise a radio transmitter for sending radio transmissions, for example. The receiver may comprise a radio receiver for receiving radio transmissions, for example.

The communication interface 126 may additionally or alternatively comprise a wired communication interface. The first impulse line device 120 may, for example, be connected to the one or more other apparatus via a cable. As such, the communication interface 126 may comprise a network interface controller (NIC) and/or a computer port (e.g. a physical outlet to which a plug or cable connects), and/or a network socket, etc. In some examples, the first impulse line device 120 may be operable to communicate with the one or more other apparatus over a network, such as the network 150. The communication interface 126 may thus comprise a network interface.

The second impulse line device 130 comprises a second impulse line 132, a second sensor 134 and a second communication interface 136.

The second impulse line 132 may comprise a vessel, such as a pipe or a tube, for receiving material from the system 110. In some examples, the second impulse line 132 may comprise a second pipe having a narrower diameter (e.g. a smaller gauge) than a second pipe of the system 110 to which it is connected. The second impulse line 132 is operatively connected to the system 110. The second impulse line 132 may thus be connected to the system 110 in such a manner to allow material to flow from the system 110 to the second impulse line 132. The second impulse line 132 may be described as being fluidly connected to, or in fluid connection with, the system 110.

The second impulse line 132 may be connected to the system 110 via one or more valves (not illustrated). The one or more valves may be actuatable (e.g. openable) to cause the second impulse line 132 to be fluidly connected the system 110 when it was previously fluidly disconnected. The one or more valves may be actuatable (e.g. closeable) to cause the second impulse line 132 to be fluidly disconnected the system 110 when it was previously fluidly connected. Alternatively, the second impulse line 132 may be connected to the system 110 without any intervening valves.

The second sensor 134 is for measuring a property of contents of the second impulse line 132. Material may flow from the system 110 into the second impulse line 132, where it can be measured by the second sensor 134. The second impulse line 132 may thus effectively connect a point in the system 110 at which a property is to be measured with the second sensor 134 for measuring that property. The second sensor 134 may thus be described as being operable to or configured for measuring the property of the contents of the second impulse line 132. The property may be any property of a flowable material that is measurable with a sensor 134. The property of the contents of the second impulse line 132 may be the same or different to the property of the contents of the first impulse line 122. In some examples, the property may include one of more of: pressure, level and flow. The second sensor 134 may comprise one or more of: a pressure sensor, a level sensor and a flowmeter. A single second sensor 134 is illustrated in FIG. 1, but in general the second impulse line device 130 may comprise one or more second sensors 134. The one or more second sensors 134 may be operable to measure the same property or respective different properties. For example, the second impulse line device 130 may comprise two pressure sensors such that one pressure sensor can provide redundancy if the other pressure sensor malfunctions. In another example, the second impulse line device 130 may comprise a pressure sensor and a level sensor, in which the pressure sensor is operable to measure a pressure of the contents of the second impulse line 132 and the level sensor is operable to measure the level of the contents of the second impulse line 132.

The second communication interface 136 is for communicating with one or more other apparatus (e.g. with the database 140, the computing device 160 and/or the user device 170). The structure of the communication interface 136 may depend on how the second impulse line device 130 interfaces with the one or more other apparatus. The communication interface 136 may comprise a wireless communication interface. For example, the communication interface 136 may comprise a transmitter with an antenna to send wireless transmissions and/or a receiver for receiving wireless transmissions. The transmitter and the receiver may be connected to the same antenna. The transmitter and the receiver may be integrated (e.g. in a transceiver). The transmitter may comprise a radio transmitter for sending radio transmissions, for example. The receiver may comprise a radio receiver for receiving radio transmissions, for example.

The communication interface 136 may additionally or alternatively comprise a wired communication interface. The second impulse line device 130 may, for example, be connected to the one or more other apparatus via a cable. As such, the communication interface 136 may comprise a network interface controller (NIC) and/or a computer port (e.g. a physical outlet to which a plug or cable connects), and/or a network socket, etc. In some examples, the second impulse line device 130 may be operable to communicate with the one or more other apparatus over a network, such as the network 150. The communication interface 136 may thus comprise a network interface.

Although the arrangement 100 is illustrated as comprising two impulse line devices 120, 130, it will be appreciated that the arrangement 100 may, in general, comprise two or more impulse line devices operatively connected to the system 110.

The database 140 comprises a processor 142, a memory 144 and a communication interface 146.

The processor 142 directly performs, or instructs the database 140 to perform, the operations described herein of the database 140, e.g. operations such as receiving one or more measurements, processing the one or more measurements, storing data based on the one or more measurements etc. The processor 142 may be implemented by one or more general purpose processors that execute instructions stored in a memory (e.g. in memory 144) or stored in another processor-readable medium. The instructions, when executed, cause the processor 142 to directly perform, or cause the database 140 to perform the operations described herein. In other embodiments, the processor 142 may be implemented using dedicated circuitry, such as a programmed field-programmable gate array (FPGA), a graphics processing unit (GPU), or an application-specific integrated circuit (ASIC).

The communication interface 146 of the database 140 is for communicating with one or more other apparatus, such as the first impulse device 120, the second impulse line device 130, the computing device 160 and/or the user device 170. The structure of the communication interface 146 may depend on how the database 140 interfaces with the one or more other apparatus. The communication interface 146 may comprise a wireless communication interface. For example, the communication interface 146 may comprise a transmitter with an antenna to send wireless transmissions and/or a receiver for receiving wireless transmissions. The transmitter and the receiver may be connected to the same antenna. The transmitter and the receiver may be integrated (e.g. in a transceiver). The transmitter may comprise a radio transmitter for sending radio transmissions, for example. The receiver may comprise a radio receiver for receiving radio transmissions, for example.

The communication interface 146 may additionally or alternatively comprise a wired communication interface. The database 140 may, for example, be connected to the one or more other apparatus via a cable. As such, the communication interface 146 may comprise a network interface controller (NIC) and/or a computer port (e.g. a physical outlet to which a plug or cable connects), and/or a network socket, etc. In some examples, the database 140 may be operable to communicate with the one or more other apparatus over a network, such as the network 150. The communication interface 146 may thus comprise a network interface.

In some examples, the database 140 may comprise a wireless communications interface for communicating with the first and second impulse line devices 120, 130 and a wired communications interface for communicating with the computing device 160 (e.g. via the network 150).

The memory 144 is for storing data based on measurements received from the first impulse line device 120 (e.g. transmitted by the communication interface 126 and received at the communication interface 146) and/or the second communication interface 136 (e.g. transmitted by the communication interface 136 and received at the communication interface 146). A single memory 144 is illustrated in FIG. 1, but in implementation the memory 144 may be distributed.

In some examples, the database 140 may be co-located with the first and/or second impulse line devices 120, 130. For example, the first and/or second impulse line devices 120, 130 may be located at a same processing plant (e.g. that houses the system 110) and the database 140 may also be located at the same processing plant. The database 140 may be connected to the first and/or second impulse line devices 120, 130 via a local area network (e.g. a local area network of the processing plant). Co-locating the database 140 with the first and/or second impulse line devices 120, 130 may allow for the database 140 to receive measurements directly from the first and/or second impulse line devices 120, 130. For example, the database 140 may receive radio transmissions transmitted by the communications interfaces 126, 136 (e.g. without necessitating any intermediate retransmitters or routing via an intermediate wired network).

In other examples, the database 140 may be remote. For example, the database 140 might be at a different location to the first and/or second impulse line devices 120, 130.

As illustrated in FIG. 1, the database 140 is connected to the computing device 160 via the network 150. The network 150 may be any suitable network over which the database 140 and the computing device 160 may communicate. The database 140 may be connected to the computing device 160 via one or more other apparatus in the network 150 (e.g. via one or more gateways).

In some examples, the computing device 160 may be remote. The computing device 160 may be at a different location to one or more of: the first impulse line device 120, the second impulse line device 130, the database 140 and the user device 170. In particular examples, the database 140 and the first and second impulse line devices 120, 130, and the user device 170 may be co-located (e.g. in the same processing plant) and the computing device 160 may be remote. Thus, data based on measurements from the first and second impulse line devices 120, 130 may be stored on-site (e.g. at or near to the location of the first and second impulse line devices 120, 130) and retrievable by the computing device 160. The computing device 160 may, for example, be housed in a data center that is remote from the site.

The computing device 160 comprises a processor 162, a memory 164 and a communication interface 166. The computing device 160 may be referred to as a server, such as a remote server.

The processor 162 directly performs, or instructs the computing device 160 to perform, the operations described herein of the computing device 160, e.g. operations such as inputting a first amount of variation and the first correlation to a model, inputting first and second measurements to a model, comparing a predicted measurement to a third measurement, comparing a difference between the first amount of variation and the second amount of variation to a threshold etc. The processor 162 may be implemented by one or more general purpose processors that execute instructions stored in a memory (e.g. in memory 164) or stored in another processor-readable medium. The instructions, when executed, cause the processor 162 to directly perform, or cause the computing device 160 to perform the operations described herein. In other embodiments, the processor 162 may be implemented using dedicated circuitry, such as a programmed field-programmable gate array (FPGA), a graphics processing unit (GPU), or an application-specific integrated circuit (ASIC).

The communication interface 166 of the computing device 160 is for communicating with one or more other apparatus, such as the database 140 (e.g. via the network 150) and/or the user device 170 (e.g. via the network 150). The structure of the communication interface 166 may depend on how the computing device 160 interfaces with the one or more other apparatus. The communication interface 166 may comprise a wireless communication interface. For example, the communication interface 166 may comprise a transmitter with an antenna to send wireless transmissions and/or a receiver for receiving wireless transmissions. The transmitter and the receiver may be connected to the same antenna. The transmitter and the receiver may be integrated (e.g. in a transceiver). The transmitter may comprise a radio transmitter for sending radio transmissions, for example. The receiver may comprise a radio receiver for receiving radio transmissions, for example.

The communication interface 166 may additionally or alternatively comprise a wired communication interface. The computing device 160 may, for example, be connected to the one or more other apparatus via a cable. For example, the computing device 160 may be connected to the network 150 by a cable. As such, the communication interface 166 may comprise a network interface controller (NIC) and/or a computer port (e.g. a physical outlet to which a plug or cable connects), and/or a network socket, etc. In some examples, the computing device 160 may be operable to communicate with the one or more other apparatus over a network, such as the network 150. The communication interface 166 may thus comprise a network interface.

A single memory 164 is illustrated in FIG. 1, but in implementation the memory 164 may be distributed.

The user device 170 comprises a processor 172, a memory 174, a communication interface 176 and a user interface 178. The user device 170 may comprise, for example, a mobile device (e.g. a smartphone, laptop, tablet), a desktop computer, or any other suitable user device 170.

The processor 172 directly performs, or instructs the user device 170 to perform, the operations described herein of the user device 170, e.g. operations such as receiving an indication, outputting an alert to a user etc. The processor 172 may be implemented by one or more general purpose processors that execute instructions stored in a memory (e.g. in memory 172) or stored in another processor-readable medium. The instructions, when executed, cause the processor 172 to directly perform, or cause the user device 170 to perform the operations described herein. In other embodiments, the processor 172 may be implemented using dedicated circuitry, such as a programmed field-programmable gate array (FPGA), a graphics processing unit (GPU), or an application-specific integrated circuit (ASIC).

The communication interface 176 of the user device 170 is for communicating with one or more other apparatus, such as the first impulse device 120, the second impulse line device 130, the computing device 160 and/or the user device 170. The communication interface 176 may receive communications from the computing device 160 via the network 150, for example. The structure of the communication interface 176 may depend on how the user device 170 interfaces with the one or more other apparatus. The communication interface 176 may comprise a wireless communication interface. For example, the communication interface 176 may comprise a transmitter with an antenna to send wireless transmissions and/or a receiver for receiving wireless transmissions. The transmitter and the receiver may be connected to the same antenna. The transmitter and the receiver may be integrated (e.g. in a transceiver). The transmitter may comprise a radio transmitter for sending radio transmissions, for example. The receiver may comprise a radio receiver for receiving radio transmissions, for example.

The communication interface 176 may additionally or alternatively comprise a wired communication interface. The user device 170 may, for example, be connected to the one or more other apparatus via a cable. As such, the communication interface 176 may comprise a network interface controller (NIC) and/or a computer port (e.g. a physical outlet to which a plug or cable connects), and/or a network socket, etc. In some examples, the user device 170 may be operable to communicate with the one or more other apparatus over a network, such as the network 150. The communication interface 176 may thus comprise a network interface.

A single memory 174 is illustrated in FIG. 1, but in implementation the memory 174 may be distributed.

The user interface 178 is for outputting information, such as an alert, to a user. The user may alternatively be referred to as a human operator. The user interface 178 may comprise an output device e.g. any suitable means for outputting information. The user interface 178 may be implemented as a display screen (which may be a touch screen) and/or a speaker (e.g. in an earbud or headset), for example. The user interface 178 may comprise an input device for a user to input information to the user device 170. The user interface 178 may comprise, for example, a touch screen, a keyboard, and/or a mouse, etc., depending upon the implementation.

Although the user interface 178 is illustrated as being part of the user device 170, in general the user interface 178 may be associated with the user device 170. Thus, the user interface 178 may form a part of or be connected to the user device 170. The user interface 178 may be connected to the user device 170 via wireless connection. The user interface 178 may be connected to the user device 170 via wired connection.

In some embodiments, the user device 170 may comprise (e.g. may be) a controller of the first impulse line device 120 and/or the second impulse line device 130. For example, the first and/or second impulse line devices 120, 130 may be located at a particular processing plant, and the controller may be a controller for the processing plant. The controller may, for example, output status information for the plant to allow a user to monitor the plant. A user may be able to use the controller to perform one or more control actions in relation to the plant, such as the one or more actions described below.

In the arrangement 100, the first impulse line device 120 may transmit measurements performed (e.g. by the first sensor 124) on the contents of the first impulse line 122 to the database 140 and/or the computing device 160. The second impulse line device 130 may also transmit measurements performed (e.g. by the second sensor 134) on the contents of the second impulse line 132 to the database 140 and/or the computing device 160. Since the contents of the contents of the first and second impulse lines 122, 132 is received from the system 110, this can allow the properties of the material in the system 110 to be monitored. This may be particularly useful for monitoring properties such as the pressure, level and/or flow of material in the system 110.

However, a malfunction associated with one of the first and second impulse lines 122, 132 may occur, which may cause erroneous measurements to be received at the computing device 160 and/or the database 140. There are various malfunctions associated with a particular impulse line that may occur. Examples of such malfunctions include: clogging (or plugging) of the impulse line, miscalibration of a sensor for performing measurements on the contents of the impulse line (e.g. one of the sensors 124, 134), a transmission error in a communication interface for transmitting measurements performed on the contents of the impulse line (e.g. one of the communication interfaces 126, 136), etc. There are various situations in which an impulse line may clog depending on the contents of the impulse line, its configuration, its environment etc. One particular problem that can occur is the clogging of an impulse line due to freezing. An impulse line can freeze when a fluid contained in the impulse line freezes or a gas in the impulse line condensate to clog the impulse line. This can be a particular problem for impulse lines in cold environments.

A malfunction associated with one of the impulse lines 122, 132 may result in the computing device 160 and/or the database 140 receiving incorrect measurements of the property of the contents of the respective impulse line. As these measurements may be used to monitor the system 110 and inform management decisions (e.g. regarding maintenance) for the system 110, the provision of incorrect measurements can result in a process upset or a plant tripping. In extreme cases, a frozen impulse line can rupture. Process fluid leaks can result in product loss, energy loss, measurement errors, and can be a serious threat to personnel safety and the environment.

According to the present disclosure, methods and apparatus for detecting a malfunction associated with an impulse line are provided. In some examples, the methods and apparatus described herein may be used to detect a malfunction associated with an impulse line without necessitating any specialist hardware. Thus, some of the examples described herein may be easily implemented to detect malfunction in existing systems (e.g. without modifying the existing system). By avoiding the need to implement specialist hardware (e.g. specialist or adapted impulse lines) to detect a malfunction associated with an impulse line connected to a system, examples of the present disclosure may be implemented without disrupting the operation of the system. This can extend the lifetime of existing impulse lines and reduce implementation costs.

In some examples, measurements performed on the contents of the first impulse line 122 and the second impulse line 132 may be used to detect whether a malfunction associated with the first impulse line 122 has occurred. Using measurements to detect whether a malfunction has occurred can be challenging because measurements performed on impulse lines are often noisy. This means there is a risk that noise in the measurements may be mistaken for a malfunction, resulting in a false detection. Aspects of the present disclosure provide methods for using these measurements to detect whether a malfunction has occurred whilst reducing the risk of a false detection.

### Method 200

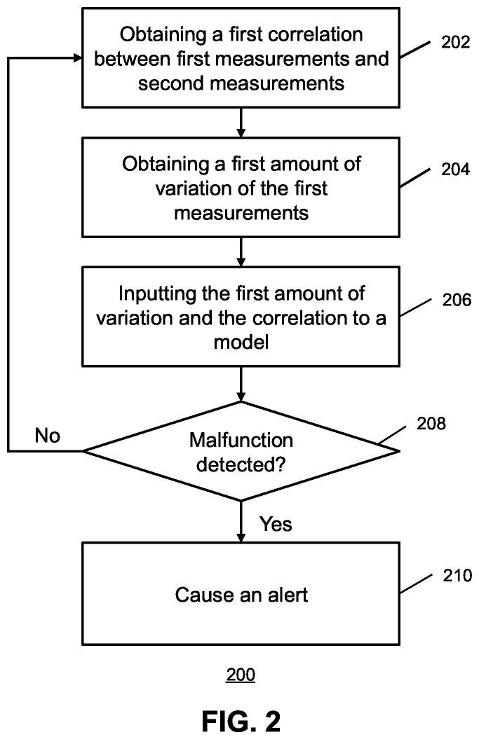

FIG. 2 shows a flowchart of a method 200 performed by the computing device 160 according to embodiments of the disclosure. The method 200 may be for detecting a malfunction associated with the first impulse line 122.

In step 202, the computing device 160 may obtain a first correlation between first measurements performed on contents of the first impulse line 122 and second measurements performed on contents of the second impulse line 132.

The first impulse line 122 and the second impulse line 132 may be fluidly connected to a same part of the system 110. That is, there may be at least one part of the system 110 (e.g. one point or location in the system 110) that is fluidly connected to both the first impulse line 122 and the second impulse line 132. In general, a first component may be fluidly connected to a second component when a fluid may be permitted to flow from the first component to the second component and/or from the second component to the first component. The first and second component need not be directly connected to be fluidly connected. That is, there may be one or more intermediate components between fluidly connected components.

The first impulse line 122 may be upstream or downstream of the second impulse line 132. That is, the first impulse line 122 may be operatively connected to the system 110 (e.g. connected to receive material from the system 110) at a point in the system 110 that is upstream or downstream from the point in the system 110 at which the second impulse line 132 is operatively connected. As such, one or more properties of the contents of the first impulse line may be expected to be correlated with one or more properties of the contents of the second impulse line.

In other examples, the first impulse line 122 may be fluidly connected to a same part of the system 110 without being upstream or downstream of the second impulse line 132. For example, the first impulse line 122 may be operatively connected to a first pipe of the system 110 and the second impulse line 132 may be operatively connected to a second pipe of the system 110, in which the first and second pipe are connected in parallel.

The first measurements may be performed by the first sensor 124 on the contents of the first impulse line 122. The second measurements may be performed by the second sensor 134 on the contents of the second impulse line 132.

The first measurements may be performed in a first time window. A time window may be an interval or period of time (e.g. a time between a start time and an end time). The second measurements may be performed in a second time window.

The first and second time windows may overlap. That is, the times at which the first measurements are performed may overlap with the times at which the second measurements are performed. In some examples, the first and second time measurements may start and end at the same time (e.g. the first and second time windows may be the same). In other examples, the first and second time measurements may start at different times and/or end at different times.

In some examples, the first and/or second time windows may have a duration of between 60-100 minutes. In particular examples, the first and second time windows may start at the same time, and may both have a duration between 60-100 minutes.

In some examples, each of the first measurements may be performed at the same time as a corresponding measurement in the second measurements. For example, the first measurements may comprise measurements performed at t=1, 2, 3, 4, 5 seconds and the second measurements may comprise measurements performed at t=1, 2, 3, 4, 5 seconds. In some examples, the first measurements and the second measurements might be performed at different times in the first time window. For example, the time window may be 1≤ t/seconds≤6 and the first measurements may be performed at t=1, 3, 5 seconds and the second time measurements may be performed at t=2, 4, 6 seconds. In some examples, at least one of the first measurements may be performed at the same time in the first time window to at least one of the second measurements but at least one other of the first measurements may be performed at a different time in the first time window to the second measurements.

In some examples, the first measurements and the second measurements may be performed at different times at the point of measurements, but may be processed to have the same measurement interval (e.g. to obtain 1 minute time-weighted average data).

The first measurements may comprise measurements of a first property of the contents of the first impulse line 122. The first property may comprise one or more of: a pressure, flow and level of the contents. The second measurements may comprise measurements of a second property of the contents of the first impulse line 122. The second property may comprise one or more of: a pressure, flow and level of the contents.

The first property and the second property may be the same. For example, the first measurements may comprise pressure measurements of the contents of the first impulse line 122 and the second measurements may comprise pressure measurements of the contents of the second impulse line 132. Alternatively, the first property and the second property may be different. For example, the first measurements may comprise pressure measurements of the contents of the first impulse line 122 and the second measurements may comprise level measurements of the contents of the second impulse line 132.

The computing device 160 may, in step 202, receive the first measurements. The computing device 160 may receive the first measurements from the database 140 (e.g. transmitted by the communication interface 146 of the database 140 to the communication interface 166 of the computing device 160). The computing device 160 may receive the first measurements from the database 140 via the network 150, for example. The computing device 160 may, alternatively, receive the first measurements from the first impulse line device 120 (e.g. transmitted by the communication interface 126 of the first impulse line device 120 to the communication interface 166 of the computing device 160). For example, a transmitter of the first impulse line device 120 may transmit the first measurements to a receiver of the computing device 160. In some examples, the first impulse line device 120 may be connected to the network 150 (e.g. with or without the database 140 as an intermediary) and may transmit the first measurements to the computing device 160 via the network 150.

The computing device 160 may, in step 202, receive the second measurements. The computing device 160 may receive the second measurements using any of the approaches described above in respect of receiving the first measurements, but in respect of the second impulse line device 130 instead of the first impulse line device 120. For example, the computing device 160 may receive the second measurements from the database 140 (e.g. via the network 150). In another example, the computing device 160 may, alternatively, receive the first measurements from the second impulse line device 130.

The computing device 160 may receive the first and/or second measurements on request. The computing device 160 may, for example, transmit a request for the first and/or second measurements (e.g. to the database 140, to the first impulse line device 120 and/or the second impulse line device 130) and receive a respective response (e.g. transmitted by the communication interface 146, the communication interface 126 and/or communication interface 136), comprising the first and/or second measurements. In another example, the computing device 160 may receive the first and/or second measurements at predetermined time intervals (e.g. every second). In another example, the computing device 160 may receive the first and/or second measurements from the first and/or second impulse devices 120, 130 as they are performed by the first and/or second sensors 124, 134.

The computing device 160 may, in step 202, determine the first correlation between the first measurements and the second measurements. That is, the computing device 160 may calculate the first correlation using the first measurements and second measurements received as described above.

The first correlation may be any suitable measure (e.g. parametrization of) correlation between the first measurements and the second measurements. The first correlation may comprise any suitable correlation coefficient, for example. The first correlation may comprise any one of: a Pearson product-moment correlation coefficient, an intraclass correlation and a rank correlation. In some examples, the first correlation may comprise a function of one or more correlation coefficients. For example, the first correlation may comprise a function of one or more of: a Pearson product-moment correlation coefficient, an intraclass correlation and a rank correlation.

In an example, the computing device 160 may determine the first correlation between the first and second measurements by pairing respective measurements in the first and second measurements to form a dataset {(x₁, y₁), . . . , (x_{N}, Y_{N})} in which xᵢ is a measurement from the first measurements paired with a respective measurement y; from the second measurements for N pairs of measurements. The computing device 160 may pair measurements that are performed at a same time (e.g. at exactly the same time or within an amount of tolerance, such as within 0.5 seconds), for example. The computing device 160 may determine the first correlation according to:

$${r}_{xy} = \frac{{\sum }_{i}^{N} ( {x}_{i} - \overline{x} ) ( {y}_{i} - \overline{y} )}{\sqrt{{\sum }_{i}^{N} {( {x}_{i} - \overline{x} )}^{2}} \sqrt{{\sum }_{i}^{N} {( {y}_{i} - \overline{y} )}^{2}}} ,$$

in which rxy is a Pearson product-moment correlation coefficient.

In general, the computing device 160 may determine the first correlation between the first measurements and the second measurements using any suitable approach.

In other embodiments, the computing device 160 might not determine the first correlation between the first measurements and the second measurements. The computing device 160 may, in step 202, receive the first correlation. The computing device 160 may, for example, receive the first correlation from the database 140. The database 140 may, for example, receive the first measurements (e.g. from the first impulse line device 120) and the second measurements (e.g. from the second impulse line device 130) and determine the first correlation between the first measurements and the second measurements. The database 140 may determine the first correlation using any of the approaches described above in respect of the computing device 160, for example.

In step 204, the computing device 160 may obtain a first amount of variation of the first measurements. The first amount of variation may indicate the dispersion or spread of the values of the first measurements. As described above, the first measurements may be performed by the first sensor 124 on the contents of the first impulse line 122 in the first time window. As such, the computing device 160 may indicate the dispersion or spread of values of measurements performed by the first sensor 124 on the contents of the first impulse line 122 in the first time window.

The first amount of variation of the first measurements may comprise any measure of variation of the first measurements. The amount of variation of the first measurements may comprise one or more of: a variance of the first measurements, a standard deviation of the first measurements, a percentile (e.g. a quartile) of the first measurements, a range of the first measurements and an inter-percentile range (e.g. an interquartile range) of the first measurements. In some examples, the first amount of variation of the first measurements may be based on the deviation of the first measurements from the mean of the first measurements. That is, the first amount of variation of the first measurements may be based on the quantity Σᵢ^{N}(xᵢ−x̅)², in which the first measurements comprise N first measurements xᵢ and x̅ is the mean of the first measurements. For example, the first amount of variation of the first measurements may be determined according to:

$$σ = \sqrt{\frac{1}{N} {\sum }_{i}^{N} {( {x}_{i} - \overline{x} )}^{2} ,}$$

in which σ is the standard deviation of the first measurements.

The computing device 160 may obtain the first amount of variation by determining the first amount of variation of the first measurements. Alternatively, the computing device 160 may receive the first amount of variation.

The computing device 160 may receive the first amount of variation from the database 140 (e.g. transmitted by the communication interface 146 of the database 140 to the communication interface 166 of the computing device 160). The computing device 160 may receive the first amount of variation from the database 140 via the network 150, for example. The processor 142 of the database 140 may, for example, determine the first amount of variation based on the first measurements received from the first impulse line device 120.

The computing device 160 may, alternatively, receive the first amount of variation from the first impulse line device 120 (e.g. transmitted by the communication interface 126 of the first impulse line device 120 to the communication interface 166 of the computing device 160). In some examples, the first impulse line device 120 may comprise a processor and the processor may determine the first amount of variation based on the first measurements performed by the sensor 124. A transmitter of the first impulse line device 120 may transmit the first amount of variation to a receiver of the computing device 160. In some examples, the first impulse line device 120 may be connected to the network 150 (e.g. with or without the database 140 as an intermediary) and may transmit the first amount of variation to the computing device 160 via the network 150.

In step 206, the computing device 160 may input the first amount of variation and the first correlation to a model to detect whether (e.g. whether or not) a malfunction associated with the first impulse line 122 has occurred. The first amount of variation and the first correlation may be collectively referred to as the inputs to the model.

The model may comprise a classification model. The model may comprise a binary classification model. The binary classification model may classify the inputs to the model (e.g. the first amount of variation and the first correlation) as being indicative of a malfunction associated with the first impulse line 122 or not being indicative of a malfunction associated with the first impulse line 122In another example, the model may comprise a three class classification model. For example, the inputs may classified as being indicative of a malfunction associated with the first impulse line 122, being indicative of a process upset (e.g. a problem upstream of the first impulse line 122), or normal (e.g. not indicative of a malfunction or process upset).

The model may have been developed using a machine-learning process. The machine-learning process may also be referred to as a machine-learning algorithm. The development of the model using the machine-learning process may be referred to as training the model. The model may be developed by inputting training data to the machine-learning process. The training data may comprise the same type of data as the inputs to the model. As such, the training data may comprise a second amount of variation in third measurements performed on contents of the first impulse line 122 and a second correlation between the third measurements and fourth measurements performed on the second impulse line 132. The second amount of variation may be obtained in the same manner as the first amount of variation described above. The second correlation may be obtained in the same manner as the second correlation described above.

The training data may differ from the inputs to the model in that the third measurements and fourth measurements may be performed at different times to the first and second measurements. The third measurements may be performed in a third time window different to the first time window. The fourth measurements may be performed in a fourth time window different to the second time window. The third and fourth time window map overlap (e.g. may be the same). In some examples, the third and fourth measurements may be performed in an earlier time window to the first and second measurements. That is, the model may be trained using measurements performed before the measurements that are input to the trained model.

The training data may further differ from the inputs to the model in that the training data may comprise a label. The label may alternatively be referred to as a class or a category. The training data may be referred to as labeled training data. The use of labeled training data to develop the model using a machine-learning process may be referred to as supervised machine-learning.

The label may indicate whether second amount of variation and the second correlation are associated with the occurrence of a malfunction associated with the first impulse line 122. That is, the training data may comprise a label indicating whether the third measurements and fourth measurements were performed during a malfunction associated with the first impulse line 122. In particular examples, the training data may comprise at least one label indicating that a malfunction associated with the first impulse line 122 occurred. That is, in some examples, the training data may comprise a malfunction history (e.g. a freeze history) associated with the first impulse line 122. Using training data that comprises a malfunction history for the first impulse line 122 to develop the model can improve the accuracy with which the model can detect whether a malfunction associated with the first impulse line 122 has occurred.

Although the training data has been described as comprising a second amount of variation, a second correlation and a label, it will be appreciated that, in general, the training data may comprise one or more second amounts of variation, one or more second correlations and one or more labels. In some examples, the model may be developed using large set of training data, in which the training data is obtained by performing measurements on the first and second impulse lines 122, 132 in a large number of time windows.

It will be appreciated that there are many machine-learning processes that may be suitable for developing the model. In some examples, the machine-learning process may comprise one or more of: a logistic regression process, a neural network (e.g. an artificial neural network), a decision tree-based process, a support vector machine, a generative process etc. The neural network may, for example, comprise a feedforward neural network, such as a standard feedforward neural network with a minimal number of layers. The neural network may comprise a recurrent neural network. The decision tree-based process may comprise, for example, a gradient boosting process (e.g. xgboost) and/or a random forest. The generative process may comprise a Quadratic Discriminant Analysis process (QDA), for example.

The model may be developed by the computing device 160. That is, the model may be trained by the same apparatus (e.g. the same entity) that uses the model to detect whether a malfunction has occurred. Alternatively, the model may be developed elsewhere. The model may, for example, be received by the computing device 160 (e.g. after it has been developed). The model may be stored at the computing device 160 (e.g. in the memory 164).

The computing device 160 may thus, in step 208 input the first amount of variation and the first correlation to the model. It will be appreciated that the model may take one or more further inputs. That is, the computing device 160 may input data other than the first amount of variation and the first correlation to the model in step 208. In some examples, the computing device 160 may, for example, perform further analysis on the first measurements and/or the second measurements to determine the one or more further inputs.

In step 208, the computing device 160 may determine whether a malfunction associated with the first impulse line is detected. The computing device 160 may, for example, obtain a flag from the model, in which the model determined the flag based on the first amount of variation and the first correlation (e.g. and optionally the one or more further inputs described above). The flag may indicate that a malfunction has been occurred or the flag may indicate that a malfunction has not occurred. The flag may comprise a Boolean. For example, the flag may comprise a 1 or TRUE to indicate that a malfunction has occurred. The flag may comprise a 0 or FALSE to indicate that a malfunction has occurred.

In some examples, the computing device 160 may obtain a likelihood of a malfunction has occurred from the model. The model may determine the likelihood based on the first amount of variation and the first correlation (e.g. and optionally the one or more further inputs described above). The computing device 160 may determine whether the malfunction has occurred based on the likelihood. The computing device 160 may compare the likelihood to a threshold value to determine whether the malfunction has occurred, for example. The computing device 160 may determine that the malfunction has occurred responsive to determining that the likelihood exceeds a threshold value (e.g. a minimum threshold value). For example, the computing device 160 may determine that the malfunction has occurred responsive to determining that a likelihood of a malfunction having occurred of 60% exceeds a threshold value of 50%. In other examples, the threshold may be increased by up to 80%. In general, the threshold may be based on a target false positive rate or based on achieving a balance between precision and recall.

In response to detecting that the malfunction has occurred at the first impulse line 122, the computing device 160 may, in step 210, cause an alert indicating that the malfunction has been detected. Causing an alert is discussed in more detail below. The method 200 may, additionally or alternatively, return to step 202 in response to detecting that a malfunction has occurred. That is, some or all of the method 200 may be repeated with new measurements. The repetition of some or all of the method 200 is discussed in more detail below.

In some examples, the computing device 160 may only cause an alert when a threshold number of malfunctions have been detected. The computing device 160 may repeat 202-208 a number of times and only proceed to step 210 in response to the number of detected malfunctions exceeded a threshold value. For example, the computing device 160 may cause the alert responsive to detecting that 10 malfunctions have occurred at the first impulse line 122. In another example, the computing device 160 may only cause an alert when 5 consecutive alarms have occurred. The alarms may occur at intervals of one-minute. As such, this may be referred to using an on-delay timer of 5 minutes.

In some examples, the computing device 160 may perform one or more other actions responsive to detecting that the malfunction has occurred. The one or more other actions may be performed in addition to, or instead of, step 210. The one or more other actions are discussed in more detail below.

In some examples, the computing device 160 may, in response to detecting that a malfunction has not occurred, cause an alert indicating that a malfunction has not been detected (not illustrated). Alternatively, the method 200 may end in response to detecting that a malfunction has not occurred. In yet a further alternative, the method 200 may return to step 202 in response to detecting that a malfunction has not occurred. That is, some or all of the method 200 may be repeated with new measurements.

As mentioned above, some or all of the steps of the method 200 may be repeated. That is, some or all of the steps of the method 200 may be performed more than once. In some examples, the method 200 may be performed at particular time intervals. For example, the method 200 may be initiated (e.g. may start with step 202) every minute. In some examples, the method 200 may be performed each time new first and/or second measurements are obtained (e.g. each time the new measurements are performed at the respective impulse line 122, 132 or received by the computing device 160).

In some examples, the first and/or second measurements may be performed in sliding time windows. That is, the first time window may be a first sliding time window and/or the second time window may be a second sliding time window. A sliding time window may have a changeable start time and a changeable end time, in which the start time and end time are a separated by a fixed time duration or length. The sliding time window may alternatively be referred to as a rolling time window. Thus, for example, the correlation and/or standard deviation mentioned above may be calculated on a sliding time

The sliding time window may be advanced in time whilst keeping the length of the time window constant. The length of time over which the sliding time window is advanced may be referred to as the increment or advancement period of the sliding time window. In some examples, the sliding time window may be advanced in increments of one minute (e.g. may have an increment or advancement period of one minute). Thus, for example, the method 200 may initially be performed in respect of first and second measurements performed between a start time of t=0 minutes and an end time of t=60 minutes. The method 200 may then be repeated in respect of first and second measurements performed between a start time of t=1 minute and an end time of t=61 minutes.

By using first and/or second measurements performed in a sliding time window, the first impulse line 122 may be monitored for associated malfunctions continuously, allowing malfunctions to be detected in real-time or near real-time. Performing measurements in a sliding time window may be particularly advantageous as it carries over information from a previous sequence (e.g. previous iteration of) of the time series. Including information from lagged data helps the model better understand the trends in time series data.

The present disclosure thus provides a method 200 for detecting a malfunction associated with the first impulse line 122. By using the first correlation between the first and second measurements and the first amount of variation to detect a malfunction, the impact of noise on malfunction detection can be reduced, thereby enabling more accurate detection of malfunctions associated with the first impulse line 122.

The method 200 may be particularly advantageous in examples in which the model is developed using training data labelled with one or more malfunctions. By developing the model using training data labelled with one or more malfunctions, the model may be attuned to how a malfunction associated with the first impulse line 122 may affect the amount of variation of measurements performed on the contents of the first impulse line 122 and the correlation between measurements performed on the contents of the first impulse line 122 and the second impulse line 132. This can result in a model that can be used to detect malfunctions more accurately.

### Method 300

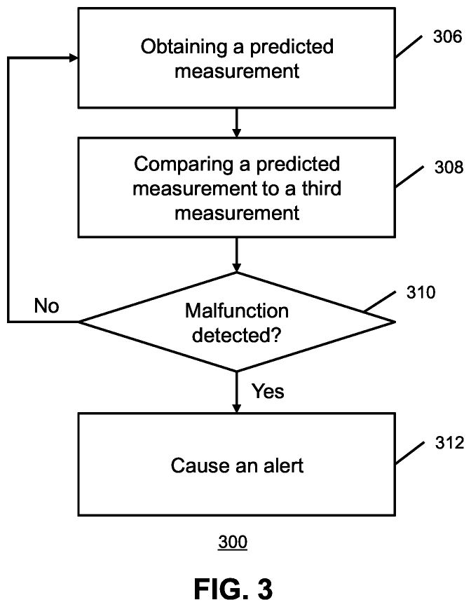

FIG. 3 shows a flowchart of a method 300 performed by the computing device 160 according to embodiments of the disclosure. The method 300 may be for detecting a malfunction associated with the first impulse line 122.

In step 306, the computing device 160 may obtain a predicted measurement for the first impulse line 122 at a first time.

The predicted measurement may comprise an expected value, or a range of expected values, of a first property of the contents of the first impulse line 122 at the second time. The first property may comprise one or more of: a pressure, flow and level of the contents. The predicted measurement may be the measurement the first sensor 124 would be expected to provide when no malfunction associated with the first impulse line 122 has occurred.

The predicted measurement may be based on a first measurement and a second measurement.

The first measurement may comprise a measurement of the first property of the contents of the first impulse line 122. The first measurement may have been performed on contents of the first impulse line 122 at a second time (e.g. at a different time to the first time). The first measurement may be performed by the first sensor 124, for example.

In some examples, the first time may be after (e.g. later than) the second time. Thus, a past (e.g. historical or earlier) measurement of the first property of the contents of the first impulse line 122 may be used, at least in part, to predict the value of the first property of the contents of the first impulse line 122 at a later time. In some examples, the first time may differ from the second time by a configured amount. For example, the first time may be N minutes after the second time, in which N may be a configurable value. In a particular example, N=3 such that the first time is 3 minutes after the second time. In another example, N=5 such that the first time is 5 minutes after the second time. In another example, N-60 such that the first time is 60 minutes after the second time.

In some examples, the first measurement may comprise more than one measurement performed on the contents of the first impulse line 122. In these examples, the first measurement may comprise a plurality of measurements performed on the contents of the first impulse line 122. The second time may comprise a plurality of second times (e.g. defining a time window) at which the first measurements are performed. The first measurements may form a time series (e.g. may be in time order), for example. The plurality of first measurements may be performed at intervals (e.g. predetermined intervals). For example, the plurality of first measurements may be performed every 1 minute. In some examples, the first measurement may comprise an average of more than one measurement performed on the contents of the first impulse line 122. The second time may comprise an average of the times at which the more than one measurements were performed, for example. The second measurement may have been performed on contents of a second impulse line 132. The second measurement may be performed by the second sensor 134, for example.

As described above in reference to FIG. 1, the first and second impulse line 132 may be operatively connected to the system 110. In this example, the first impulse line 122 and the second impulse line 132 may be fluidly connected to a same part of the system 110. That is, there may be at least one part of the system 110 (e.g. one point or location in the system 110) that is fluidly connected to both the first impulse line 122 and the second impulse line 132. In general, a first component may be fluidly connected to a second component when a fluid may be permitted to flow from the first component to the second component and/or from the second component to the first component. The first and second component need not be directly connected to be fluidly connected. That is, there may be one or more intermediate components between fluidly connected components.

In some examples, the first impulse line 122 may be upstream or downstream of the second impulse line 132. That is, the first impulse line 122 may be operatively connected to the system 110 (e.g. connected to receive material from the system 110) at a point in the system 110 that is upstream or downstream from the point in the system 110 at which the second impulse line 132 is operatively connected. As such, one or more properties of the contents of the first impulse line may be expected to be correlated with one or more properties of the contents of the second impulse line.

In other examples, the first impulse line 122 may be fluidly connected to a same part of the system 110 without being upstream or downstream of the second impulse line 132. For example, the first impulse line 122 may be operatively connected to a first pipe of the system 110 and the second impulse line 132 may be operatively connected to a second pipe of the system 110, in which the first and second pipe are connected in parallel.

The second measurement may comprise a measurement of a second property of the contents of the second impulse line 132. The second property may comprise one or more of: a pressure, flow and level of the contents. The second property may be the same or different to the first property. For example, the first measurement may comprise a flow measurement of the contents of the first impulse line 122 and the second measurement may comprise a flow measurement of the contents of the second impulse line 132. In another example, the first measurement may comprise a pressure measurement of the contents of the first impulse line 122 and the second measurement may comprise a level measurement of the contents of the second impulse line 132.

The second measurement may be performed at the first time. That is, the predicted measurement may be for the same time (e.g. exactly the same time or within an amount of tolerance) as the time at which the second measurement is performed. Alternatively, the second measurement may be performed on the contents of the second impulse line 132 at a different time. Thus, in some examples, the predicted measurement may be for a different time to the time at which the second measurements are performed.

In some examples, the second measurement may comprise more than one measurement performed on the contents of the second impulse line 132. In these examples, the second measurement may comprise a plurality of measurements performed on the contents of the second impulse line 132. The first time may comprise a plurality of first times (e.g. defining a time window) at which the second measurements are performed. The second measurements may form a time series (e.g. may be in time order), for example. The plurality of second measurements may be performed at intervals (e.g. predetermined intervals). For example, the plurality of second measurements may be performed every 1 minute. In some examples, the second measurement may comprise an average of more than one measurement performed on the contents of the second impulse line 132. The first time may comprise an average of the times at which the more than one measurements were performed, for example.

In some examples, the computing device 160 may obtain the predicted measurement in step 306 by inputting the first and second measurements to a model. The first and second measurements may be collectively referred to as the inputs to the model.

The computing device 160 may receive the first and second measurements. The computing device 160 may receive the first measurement and/or the second measurement from the database 140 (e.g. transmitted by the communication interface 146 of the database 140 to the communication interface 166 of the computing device 160). The computing device 160 may receive the first measurement and/or the second measurement from the database 140 via the network 150, for example.

The computing device 160 may, alternatively, receive the first measurement from the first impulse line device 120 (e.g. transmitted by the communication interface 126 of the first impulse line device 120 to the communication interface 166 of the computing device 160). For example, a transmitter of the first impulse line device 120 may transmit the first measurement to a receiver of the computing device 160. In some examples, the first impulse line device 120 may be connected to the network 150 (e.g. with or without the database 140 as an intermediary) and may transmit the first measurement to the computing device 160 via the network 150. The computing device 160 may receive the second measurement from the second impulse line device 130 (e.g. transmitted by the communication interface 136 of the second impulse line device 130 to the communication interface 166 of the computing device 160). For example, a transmitter of the second impulse line device 130 may transmit the first measurement to a receiver of the computing device 160. In some examples, the second impulse line device 130 may be connected to the network 150 (e.g. with or without the database 140 as an intermediary) and may transmit the first measurement to the computing device 160 via the network 150.

The model may comprise a regression model. The model may be indicative of (e.g. describe) a relationship between the measurements performed on the contents of the first impulse line 122 and the contents of the second impulse line 132 such that the model may be used to predict a measurement performed on contents of the first impulse line 122 based on a measurement performed on contents of the second impulse line 132. The model may be indicative of the relationship between measurements performed on the contents of the first and second impulse lines 122, 132 when no malfunction has occurred (e.g. during normal operation of the first impulse line device 120). By providing a predicted measurement for normal operation of the first impulse line device 120, the model may allow anomalies (such as a malfunction) to be easily identified.

The model may have been developed using a machine-learning process. The machine-learning process may also be referred to as a machine-learning algorithm. The development of the model using the machine-learning process may be referred to as training the model.

The model may be developed by inputting training data to the machine-learning process. The training data may comprise the same type of data as the inputs to the model. As such, the training data may comprise a third measurement performed on contents of the first impulse line 122 and a fourth measurements performed on contents of the second impulse line 132. The third measurement may be obtained in the same manner as the first measurement described above. The fourth measurement may be obtained in the same manner as the second measurement described above.

Although the training data has been described as comprising a third measurement and a fourth measurement, it will be appreciated that, in general, the training data may comprise one or more third measurements and one or more fourth measurements. In some examples, the model may be developed using a plurality of third measurements performed on the first impulse line 122 and a plurality of fourth measurements performed on the second impulse line 132. References to the third measurement and/or the fourth measurement in the foregoing and following description may, in general, be taken to refer to one or more third measurements and/or one or more fourth measurements as appropriate.

The training data may differ from the inputs to the model in that the third measurement and fourth measurement may be performed at a different time to the first and second measurements. The third measurement may be performed at a different time to (e.g. an earlier time than) the second time. The fourth measurement may be performed at a different time to (e.g. an earlier time than) the first time. The third and fourth measurement may be performed at a same time (e.g. exactly the same time or the same time within an amount of tolerance, such as within 0.5 seconds).

In some examples, the training data may further differ from the inputs to the model in that the training data may comprise a label. The label may alternatively be referred to as a class or a category. The training data may be referred to as labeled training data. The use of labeled training data to develop the model using a machine-learning process may be referred to as supervised machine-learning.

The label may indicate whether the third measurement and the fourth measurement are associated with the occurrence of a malfunction associated with the first impulse line 122. That is, the training data may comprise a label indicating whether the third and fourth measurements were performed during a malfunction associated with the first impulse line 122. In particular examples, the training data may comprise at least one label indicating that a malfunction associated with the first impulse line 122 occurred. That is, in some examples, the training data may comprise a malfunction history (e.g. a freeze history) associated with the first impulse line 122. Using training data that comprises a malfunction history for the first impulse line 122 to develop the model can improve the accuracy with which the model can detect whether a malfunction associated with the first impulse line 122 has occurred.

In other examples, the training data might not comprise a label. The training data may be referred to as unlabeled training data. This may be particularly appropriate in examples in which a malfunction associated with the first impulse line 122 did not occur at the time at which the measurements in the training data were performed or it is not known whether such a malfunction occurred. For example, the regression model described above may be developed using unlabeled training data that is indicative of the operational ranges of the first and/or second impulse lines 122, 132.

In some examples, the training data may be processed (e.g. cleaned or refined) before being used to develop the model. This may be a further difference between the training data and the inputs to the model. That is, in some examples, the processing applied to the training data before it is used to develop the model might not be applied to the inputs to the model (e.g. to the first measurement and/or the second measurement) before they are input to the model in step 306.

In some examples, after processing, the third measurement may comprise a plurality of third measurements that are indicative of the operational range of the first impulse line 122. The third measurements may be processed (e.g. cleaned) such that each of the third measurements is within a range of values that are expected to result when there are no malfunctions associated with the first impulse line 122 (e.g. when the first impulse line is not clogged and/or the first sensor 124 is functioning and/or the first communication interface 126 is functioning). This range of values may be referred to as the envelope of normal operations. Thus, the third measurements may be processed to limit the values of the first measurements to the envelope of normal operations. The processing may involve, for example, denoising the third measurements (e.g. removing noise from the measurements). The processing may involve removing one or more outliers from the third measurements. For example, the processing may involve removing an outlier that is more than a threshold difference from an average value of the third measurements. The processing may involve clipping the third measurements. For example, the processing may involve applying a floor to the third measurements. The floor may be a minimum lower value for the third measurements. The processing may involve applying a ceiling to the third measurements. The ceiling may be a maximum upper value for the third measurements. In general, the third measurement(s) may be processed (e.g. before being input to the model) using any suitable technique, including any combination of the aforementioned techniques.

The fourth measurement may be processed in the same way as or a similar way to the third measurement. In some examples, after processing, the fourth measurement may comprise a plurality of fourth measurements that are indicative of the operational range of the second impulse line 132. In general, the fourth measurement(s) may be processed (e.g. before being input to the model) using any suitable technique, including any combination of the techniques described above in respect of the third measurement.

The processing of the training data (e.g. of the third measurement and/or the fourth measurement) may be performed manually. This may involve inspection of the third measurement and/or fourth measurement by a human operator. Alternatively, the processing may be performed by a processor, such as the processor 142 and/or the processor 162. In some examples, the third measurement may be processed by a processor at the first impulse line device 120 (e.g. before being transmitted to the database 140). In some examples, the fourth measurement may be processed by a processor at the second impulse line device 130 (e.g. before being is transmitted to the database 140). In some examples, the training data may be processed by a human operator and a processor before it is used to develop the model.

Processing the third measurement and/or the fourth measurement prior to developing the model such that the third and/or fourth measurements are indicative of the operational ranges of the first and/or second impulse lines 122, 132 respectively may result in a model that is more accurately able to predict measurements for the first impulse line 122. That is, the model may be more accurately be able to predict a property of the contents of the first impulse line 122 when it is developed using training data processed in this manner. In particular, processing third and/or fourth measurements as described above may prevent any measurements that are affected by a malfunction associated with the first impulse line 122 and/or the second impulse line 132 from biasing the model.

It will be appreciated that there are many machine-learning processes that may be suitable for developing the model. In some examples, the machine-learning process may comprise one or more of: a partial least-square (PLS) process, a decision-based process etc. The decision-based model may, for example comprise a decision tree-based process, such as a gradient boosting process (e.g. xgboost) or a random forest.

The model may be developed by the computing device 160. That is, the model may be trained by the same apparatus (e.g. the same entity) that uses the model to detect whether a malfunction has occurred. Alternatively, the model may be developed elsewhere. The model may, for example, be received by the computing device 160 (e.g. after it has been developed). The model may be stored at the computing device 160 (e.g. in the memory 164).

The computing device 160 may thus, in step 306, input the first measurement and the second measurement to the model to obtain the predicted measurement for the first impulse line 122 at the first time. It will be appreciated that the model may take one or more further inputs. That is, the computing device 160 may input data other than the first measurement and the second measurement to the model in step 306. In some examples, the computing device 160 may, for example, perform further analysis on the first measurement and/or the second measurement to determine the one or more further inputs.

In other examples, the computing device 160 may obtain the predicted measurement by receiving the predicted measurement. The predicted measurement may be determined elsewhere (e.g. using the approach described above) and transmitted to the computing device 160. The computing device 160 may receive the predicted measurement from the database 140, for example.

In step 308, the computing device 160 may compare the predicted measurement to a fifth measurement.

The fifth measurement may have been performed using the first impulse line 122 at the first time. As mentioned above, the predicted measurement may be for the first impulse line 122 at the first time. As such, step 308 may involve the computing device 160 comparing a prediction of the first property of the contents of the first impulse line 122 at a particular time to the measurement of the first property performed (e.g. by the first sensor 124) on the contents of the first impulse line 122 at the particular time. Step 308 may thus involve comparing a prediction of the model with the actual measurement obtained by the first impulse line device 120.

Comparing the predicted measurement to the fifth measurement may involve determining a difference between the predicted measurement and the fifth measurement. Determining the difference may involve subtracting the predicted measurement from the fifth measurement or vice-versa. The difference may be an absolute difference (e.g. such that it does not matter which measurement is subtracted from the other).

In step 310, the computing device 160 may detect whether a malfunction associated with the first impulse line 122 has occurred. The computing device 160 may detected whether the malfunction has occurred based on the comparison performed in step 308.

As mentioned above, the predicted measurement may be the measurement the first sensor 124 would be expected to provide when no malfunction associated with the first impulse line 122 has occurred. As such, a difference between the predicted measurement and the fifth measurement may indicate that a malfunction has occurred. However, it will be appreciated that, in general, the predicted measurement and the fifth measurement might not be exactly the same (e.g. due to noise in the fifth measurement and/or due to an inaccuracy in the predicted measurement). Therefore, the difference between the predicted measurement and the fifth measurement might not be expected to be zero, even when no malfunction has occurred.

In some examples, the computing device 160 may detect whether a malfunction associated with the first impulse line 122 has occurred by comparing the difference between the predicted measurement and the fifth measurement to a threshold. The computing device 160 may, for example, detect that the malfunction has occurred responsive to the difference between the predicted measurement and the third measurement satisfying the threshold. For example, the computing device 160 may detect that a malfunction has occurred in response to determining that the difference (e.g. an absolute difference) between the predicted measurement and the third measurement exceeds the threshold. The threshold may thus, for example, establish the minimum difference between the prediction of the model and the actual measurement of contents of the first impulse line 122 to be met for the computing device 160 to detect a malfunction.

The value of the threshold may vary depending on the model (e.g. the accuracy of the model and/or how it is trained), the first impulse line device 120 (e.g. an amount of variation in measurements performed by the first sensor 124), etc. The value of the threshold may be determined through calibration (e.g. calibration performed automatically or by a human operator). In some examples, the threshold may equal zero. In other examples, the threshold may equal a non-zero value.

In some examples, the value of the threshold may be based on an amount of variation in measurements performed on contents of the first impulse line 122. The measurements may be historical measurements, such that the threshold is based on a spread or dispersion of measurements performed (e.g. by the sensor 125) on the contents of the first impulse line 122. The value of the threshold may, for example, be based on the amount of variation in third measurements forming part of training data used to develop the model, for example.

The amount of variation of the measurements may comprise any measure of variation of the measurements, such as any of the measures discussed above in respect of the first measurements in the method 200. For example, the amount of variation of the measurements may comprise a standard deviation, σ, of the first measurements. In example, the threshold may equal 30.

The amount of variation in measurements performed on contents of the first impulse line 122 may be indicative of the amount of noise that typically occurs in the measurements performed on contents of the first impulse line 122. Therefore, basing the threshold on the amount of variation may prevent the computing device 160 from misidentifying noise as a malfunction associated with the first impulse line 122. This may reduce the number of times a malfunction is detected erroneously (e.g. when it has not actually occurred).

In response to detecting that the malfunction has occurred at the first impulse line 122, the computing device 160 may, in step 312, cause an alert indicating that the malfunction has been detected. Causing an alert is discussed in more detail below. Step 312 may be performed in the same manner as step 210 described above. For example, the computing device 160 may, in step 312, only cause an alert when a threshold number of malfunctions have been detected.

The method 300 may, additionally or alternatively, return to step 306 in response to detecting that a malfunction has occurred. That is, some or all of the method 300 may be repeated (e.g. when a new predicted measurements is received or new first and second measurements are received for determining a new predicted measurement).

In some examples, the computing device 160 may perform one or more other actions responsive to detecting that the malfunction has occurred. The one or more other actions may be performed in addition to, or instead of, step 312. The one or more other actions are discussed in more detail below.

In some examples, the computing device 160 may, in response to detecting that a malfunction has not occurred in step 310, cause an alert indicating that a malfunction has not been detected (not illustrated). Alternatively, the method 300 may end in response to detecting that a malfunction has not occurred. In yet a further alternative, the method 300 may return to step 306 in response to detecting that a malfunction has not occurred. That is, some or all of the method 300 may be repeated with new measurements.

As mentioned above, some or all of the steps of the method 300 may be repeated. That is, some or all of the steps of the method 300 may be performed more than once. In some examples, the method 300 may be performed at particular time intervals. For example, the method 300 may be initiated (e.g. may start with step 306) every minute. In some examples, the method 300 may be performed each time a new predicted measurement is obtained or each time new first and/or second measurements are obtained (e.g. each time the new measurements are performed at the respective impulse line 122, 132 or received by the computing device 160).

The present disclosure thus provides a method 300 for detecting a malfunction associated with the first impulse line 122. By using measurements performed on the first impulse line 122 at a second time and measurements performed on the second impulse line 132 to predict a measurement performed on the first impulse line 122 at a first (different) time, the method 300 allows for identifying differences in measurements performed on the first impulse line 122 that may have arisen (e.g. were like to have arisen) due to a malfunction associated with the first impulse line 122. That is, the method 300 may allow for identifying anomalies in the measurements performed on the first impulse line 122. The method 300 may thus be referred to as an anomaly detection method. The method 300 may be particularly advantageous since it may enable detecting a malfunction associated with an impulse line even when there is no history of malfunction associated with the impulse line. As such, the method 300 may allow for blind detection of a malfunction associated with an impulse line.

Using Training Data Associated with a Different Impulse Line

As described above, the respective models that may be used in the methods 200 and 300 may be developed by inputting training data to a machine-learning process. In the preceding description, the respective models are described as being developed using training data comprising measurements performed on the first impulse line 122 and the second impulse line 132. That is, the measurements used to develop the model are performed on the same impulse lines as the measurements used for input to the model. In this way, the developed model may be specific to the first and second impulse lines 122, 132. This may be particularly advantageous since it may result in more accurate detection of malfunctions associated with the first impulse lines 122.

In general, the model may or might not be specific to the first and second impulse lines 122, 132. In some examples, the model may be developed using training data comprising measurements performed on one or more other impulse lines (e.g. as an addition or alternative to measurements performed on the first and second impulse lines 122, 132).

### Training a Model in Use

In the description of the development of the respective models that may be used in the methods 200 and 300 above, the models are described as having been developed (e.g. before they are used). In some examples, further development of a particular model may be performed after the model is used (e.g. after steps 206 and/or 306). For example, the inputs and outputs of the models described above may be used as training data for further development of the model. In this way, the models may, for example, be further developed after each iteration of the respective method 200, 300, or at intervals (e.g. once the method 200, 300 has been performed a particular number of times). As such, the models may be trained (e.g. continuously) during use. This may be referred to as re-training the model. The ongoing development of the respective model may be performed by the computing device 160 or another apparatus (e.g. another entity). For example, the computing device 160 may send the model inputs and output to another apparatus to continue development of the model. By training the respective models in use, the accuracy of the model may be further improved over time. This may also allow for adapting the model to changes in the system 110, the first impulse line device 120, the second impulse line device 130 etc. over time (e.g. due to component degradation, change in environment etc.).

### Method 400

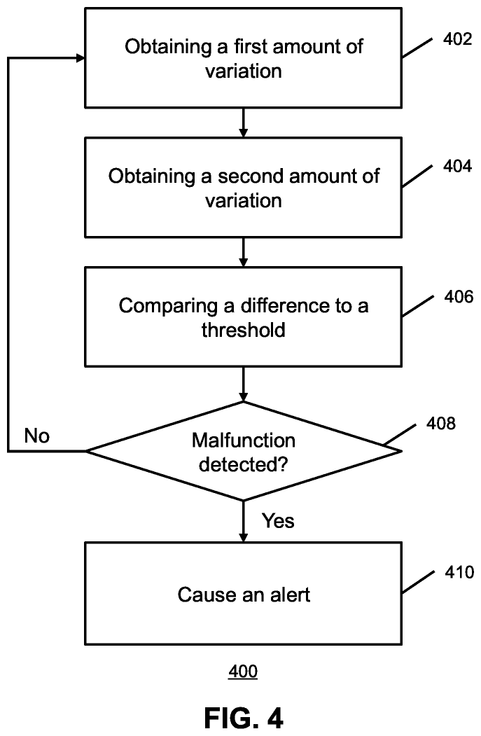

FIG. 4 shows a flowchart of a method 400 performed by the computing device 160 according to embodiments of the disclosure. The method 400 may be for detecting a malfunction associated with the first impulse line 122.

In step 402, the computing device 160 may obtain a first amount of variation in first measurements of a property of contents of the first impulse line 122.

The property of the contents of the first impulse line 122 may comprise one or more of: a pressure, flow and level of the contents of the first impulse line 122. For example, the first measurements may comprise pressure measurements.

The first measurements may be performed by the first sensor 124. The first measurements may be performed in a first time window. The first amount of variation of the first measurements may comprise any measure of variation of the first measurements, such as any of the measures discussed above in respect of the first measurements in the method 200. For example, the first amount of variation of the first measurements may comprise a standard deviation, σ, of the first measurements.

The computing device 160 may obtain the first amount of variation by determining the first amount of variation of the first measurements. The computing device 160 may receive the first measurements. The computing device 160 may receive the first measurements from the database 140 (e.g. transmitted by the communication interface 146 of the database 140 to the communication interface 166 of the computing device 160). The computing device 160 may receive the first measurements from the database 140 via the network 150, for example. The computing device 160 may, alternatively, receive the first measurements from the first impulse line device 120 (e.g. transmitted by the communication interface 126 of the first impulse line device 120 to the communication interface 166 of the computing device 160). For example, a transmitter of the first impulse line device 120 may transmit the first measurements to a receiver of the computing device 160. In some examples, the first impulse line device 120 may be connected to the network 150 (e.g. with or without the database 140 as an intermediary) and may transmit the first measurements to the computing device 160 via the network 150.

In some embodiments, the computing device 160 might not determine the first amount of variation. The computing device 160 may receive the first amount of variation of the first measurements.

The computing device 160 may receive the first amount of variation from the database 140 (e.g. transmitted by the communication interface 146 of the database 140 to the communication interface 166 of the computing device 160). The computing device 160 may receive the first amount of variation from the database 140 via the network 150, for example. The processor 142 of the database 140 may, for example, determine the first amount of variation based on the first measurements received from the first impulse line device 120.

The computing device 160 may, alternatively, receive the first amount of variation from the first impulse line device 120 (e.g. transmitted by the communication interface 126 of the first impulse line device 120 to the communication interface 166 of the computing device 160). In some examples, the first impulse line device 120 may comprise a processor and the processor may determine the first amount of variation based on the first measurements performed by the sensor 124. A transmitter of the first impulse line device 120 may transmit the first amount of variation to a receiver of the computing device 160. In some examples, the first impulse line device 120 may be connected to the network 150 (e.g. with or without the database 140 as an intermediary) and may transmit the first amount of variation to the computing device 160 via the network 150.

In step 404, the computing device 160 may obtain a second amount of variation in second measurements of the property of contents of the second impulse line 132.

The second measurements may be performed by the second sensor 134.

The first and second measurements may measure the same property of the contents of the respective impulse lines 122, 132. For example, the first measurements may comprise pressure measurements and the second measurements may comprise pressure measurements.

The second impulse line 132 may be operatively connected to the system 110 to provide redundancy for the first impulse line 122. That is, the second impulse line 132 may be connected to the system 110 in such a manner (e.g. at a particular point and/or in a particular configuration) such that the first and second impulse lines 132 may be expected to provide the same measurements of the property (e.g. exactly the same or within a tolerance).

The first and second impulse lines 122, 132 may be fluidly connected to a same part of the system 110. The first impulse line 122 may be upstream, downstream or parallel to the second impulse line 132 for example. However, it will be appreciated that, in general, two impulse lines may be fluidly connected to a same part of a system without providing redundancy for one another. For example, two impulse line devices connected to a system in parallel might measure the same flow rates or different flow rates, depending on the configuration of the system.

The particular way in which the first impulse line 122, second impulse line 132 and/or the system are configured (e.g. arranged) to achieve redundancy between the first impulse line 122 and the second impulse line 132 may vary in implementation depending on the system 132 and/or the property.

In some examples, the first and second impulse lines 122, 132 may be operatively connected to a same part of the system 110 such that the second impulse line 132 provides redundancy for the first impulse line 122. That is, the first and second impulse lines 122, 132 may receive material from the same part of the system 110. The first and second impulse lines 132 may receive material from a same vessel in the system 110, such as a same pipe or tube, for example. The first and second impulse line devices 120, 130 may, for example, measure the same processing stream. In another example, the first and second impulse line devices 120, 130 may measure the same service in a process. In some examples, the first and second impulse lines 122, 132 may be operatively connected to the same line. A line may be a part of a system which is expected to have the same properties or characteristics (e.g. pressure, level and/or flow) at its beginning and end.

In some examples, the first and second impulse lines 122, 132 may be operatively connected to same part of the system 110 such that they receive material flowing in the same direction. For example, the first sensor 124 and the second sensor 134 may both measure an upstream pressure. In another example, the first sensor 124 and the second sensor 134 may both measure a downstream pressure. That is, in some examples, the first and second impulse lines 122, 132 may be operatively connected to the same part of the system 110 such that the first and second sensor 134 might not be capable of measuring a differential pressure of the part of the system 110.

The computing device 160 may obtain the second amount of variation using any of the approaches described above in respect of obtaining the first amount of variation in step 402, but adapted for the second measurements, rather than the first measurements. For example, the computing device 160 may receive the second measurements (e.g. from the database 140 or the second impulse line device 130) and determine the second amount of variation based on the received second measurements. In another example, the computing device 160 may receive the second amount of variation (e.g. from the database 140 or the second impulse line device 130).

The second amount of variation of the second measurements may comprise the same measure of variation used for the first amount of variation of the first measurements. For example, step 402 may comprise obtaining a standard deviation, σ₁, of the first measurements and step 404 may comprise obtaining a standard deviation, σ₂, of the second measurements.

The second measurements may be performed in a second time window. The first and second time window may overlap. The discussion of overlapping time windows provided above in respect of the method 200 may be considered to apply to the method 400. As such, the first and second time window may overlap in the same manner as the first and second time window described above in respect of the method 200. The first measurements may be performed at the same times or different times to the second measurements (e.g. as described above in respect of the method 200). The first and/or second time windows may have a duration between 5 and 30 minutes. In some examples, the first and/or second time windows may have a duration of 10 minutes. In particular examples, the first and second time windows may start at the same time, and may both have a duration of 10 minutes. Using a time window of a duration of 10 minutes may be particularly advantageous.

In step 406, the computing device 160 may compare a difference between the first amount of variation and the second amount of variation to a threshold to detect whether a malfunction associated with the first impulse line has occurred.

The computing device 160 may, in step 406, determine the difference between the first amount of variation and the second amount of variation. Determining the difference may involve subtracting the first amount of variation from the second amount of variation or vice-versa. The difference may be an absolute difference (e.g. such that it does not matter which amount of variation is subtracted from the other).

As mentioned above, the first impulse line 122 and the second impulse line 132 may be operatively connected to the system 110 to provide redundancy to one another. As such, the first measurements performed on the contents of the first impulse line 122 and the second measurements performed on the contents of the second impulse line 132 might be expected to be the same when no malfunction has occurred. However, the values of the measurements performed on the first and second impulse lines 122, 132 may vary due to, for example, noise or differences in calibration. According to aspects of the present disclosure, the difference in the amounts of variation in the measurements performed on the first and second impulse lines 122, 132 may be used to detect a malfunction. The amounts of variation in the measurements performed on the contents of the first and second impulse lines 122, 132 may be less sensitive to noise and/or difference in calibration. Therefore, using the difference between amounts of variation in the measurements performed on the contents of the first and second impulse lines 122, 132 to detect malfunctions, may prevent the computing device 160 from misidentifying noise as a malfunction associated with the first impulse line 122. This may reduce the number of times a malfunction is detected erroneously (e.g. when it has not actually occurred).

It will be appreciated that, although the first amount of variation and the second amount of variation may be less sensitive to noise, differences in calibration etc., they might not be exactly the same. That is, the difference between the first amount of variation and the second amount of variation might not be expected to be zero, even when no malfunction has occurred.

Therefore, in step 406, the computing device 160 may detect that the malfunction has occurred responsive to the difference between the first amount of variation and the second amount of variation satisfying a threshold.

The computing device 160 may detect that a malfunction has occurred in response to determining that the difference (e.g. an absolute difference) between the first amount of variation and the second amount of variation exceeds the threshold. The threshold may thus, for example, establish the minimum difference between the amount of variation of measurements performed on the first impulse line 122 and the amount of variation of measurements performed on the second impulse line 132 to be met for the computing device 160 to detect a malfunction.

The value of the threshold may vary depending on the first impulse line device 120, the second impulse line device 130, the system 110 etc. The value of the threshold may be determined through tuning or calibration (e.g. calibration performed automatically or by a human operator). In other examples, the threshold may equal a non-zero value.

In some examples, the value of the threshold may be based on a previous difference between measurements performed on contents of the first and second impulse lines 122 and/or a previous difference between an amount of variance in measurements performed on contents of the first and second impulse lines 122. For example, the value of threshold may be based on how close measurements performed by the first sensor 124 have been to measurements performed by the second sensor 134. The value of the threshold may be higher when the first and second sensor 124, 134 have previously provided closer results (e.g. when the differences between the measurements has been smaller historically) than when the first and second sensor 124, 134 have previously been more disparate (e.g. when the differences between the measurements has been larger historically).

In response to detecting that the malfunction has occurred at the first impulse line 122, the computing device 160 may, in step 410, cause an alert indicating that the malfunction has been detected. Step 410 may be performed in the same manner as step 210 and/or step 312 described above. For example, the computing device 160 may, in step 410, only cause an alert when a threshold number of malfunctions have been detected.

The method 400 may, additionally or alternatively, return to step 402 in response to detecting that a malfunction has occurred. That is, some or all of the method 400 may be repeated with new measurements. The repetition of some or all of the method 400 may be discussed in more detail below.

In some examples, the computing device 160 may perform one or more other actions responsive to detecting that the malfunction has occurred in step 408. The one or more other actions may be performed in addition to, or instead of, step 410. The one or more other actions are discussed in more detail below.

In some examples, the computing device 160 may, in response to detecting that a malfunction has not occurred in step 408, cause an alert indicating that a malfunction has not been detected (not illustrated). Alternatively, the method 400 may end in response to detecting that a malfunction has not occurred. In yet a further alternative, the method 400 may return to step 402 in response to detecting that a malfunction has not occurred. That is, some or all of the method 402 may be repeated with new measurements.

As mentioned above, some or all of the steps of the method 400 may be repeated. That is, some or all of the steps of the method 400 may be performed more than once. In some examples, the method 400 may be performed at particular time intervals. For example, the method 400 may be initiated (e.g. may start with step 402) every minute. In some examples, the method 400 may be performed each time new first and/or second measurements are obtained (e.g. each time the new measurements are performed at the respective impulse line 122, 132 or received by the computing device 160).

In some examples, the first and/or second measurements may be performed in sliding time windows. That is, the first time window may be a first sliding time window and/or the second time window may be a second sliding time window. A sliding time window may be defined as described above in respect of the method 200. For example, the method 400 may initially be performed in respect of first and second measurements performed between a start time of t=0 minutes and an end time of t=60 minutes. The method 400 may then be repeated in respect of first and second measurements performed between a start time of t=1 minute and an end time of t=61 minutes.

By using a first amount of variation of first measurements performed in a sliding time window and/or a second amount of variation of second measurements performed in a sliding time window, the first impulse line 122 may be monitored for associated malfunctions continuously, allowing malfunctions to be detected in real-time or near real-time.

The present disclosure thus provides a method 400 for detecting a malfunction associated with the first impulse line 122. The method 400 may be particularly advantageous since it allows for detecting a malfunction associated with the first impulse line 122 without development of a model (e.g. without training a model using machine-learning). This can reduce the time taken to implement the method 400 to detect a malfunction associated with an impulse line in a real-world system. In addition, many systems are already provided with two or more redundant impulse lines. For example, many systems are provided with a first impulse line that is used for monitoring by a controller and a second impulse line that is used for monitoring by a safety system (e.g. a backup system). As many systems are already provided with two or more redundant impulse lines, the method 400 may be easily implemented to detect malfunctions associated with impulse lines in existing systems.

### Smoothing

As described above, the methods 200, 300 and 400 may involve using measurements performed on contents of the first impulse line 122 and the contents of the second impulse line 132 to detect whether a malfunction associated with the first impulse line 122 has occurred.

In some examples, some or all of these measurements may have been smoothed before being used for the detection of whether a malfunction has occurred in the methods 200, 300, 400. Smoothing of measurements performed on contents of a particular impulse line device may be performed by the respective impulse line device (e.g. by a processor in the respective impulse line device). For example, the first impulse line device 120 may smooth the first measurements referred to in the method 200. In another example, the second impulse line device 130 may smooth the second measurements referred to in the method 200.

Alternatively, smoothing may be performed by another apparatus (e.g. another entity). In some examples, smoothing may be performed by the database 140. For example, the database 140 may receive a plurality of measurements from the first impulse line device 120 and smooth the measurements to obtain the first measurement referred to in the description of the method 300. In some examples, smoothing may be performed by the computing device 160. For example, the computing device 160 may smooth the second measurements referred to in the method 400 before determining the second amount of variation in step 404.

Smoothing may be performed using any suitable smoothing function. In some examples, smoothing may be performed using one or more of: a moving average, exponential smoothing, a kernel smoother, etc. In some examples, measurements may be smoothed by averaging the measurements over a particular time period (e.g. over a time period of one minute). By smoothing the measurements performed on the contents of the first impulse line 122 and/or the second impulse line 132, the impact of noise on the detection of malfunctions can be reduced, thereby allowing malfunctions to be detected more accurately. Averaging measurements over a time period of 1 minute may be particularly effective at reducing the impact of noise whilst still yielding a high detection rate for malfunctions.

### Causing an Alert

As described above, the computing device 160 may, in any of the methods 200, 300 and 400, cause an alert indicating that a malfunction has been detected. The alert may be referred to as an indication, notification or warning.

Causing alert may involve causing the alert to be output at a user interface, such as the user interface 178 of the user device 170. This may be used to notify an operator of the detection of a malfunction, for example. The way in which the alert is output may depend on the user interface. In an example, the outputting the alert may involve displaying a graphic (e.g. an image and/or text) on a display screen. The graphic may include, for example, a graph indicating a number of malfunctions detected over time. In some examples, outputting the alert may involve emitting a sound from a speaker.

In some examples, causing the alert may involve updating an existing alert to include an indication that the malfunction has been detected. For example, causing the alert may involve updating a graph being displayed on a display screen to show that an additional malfunction has been detected.

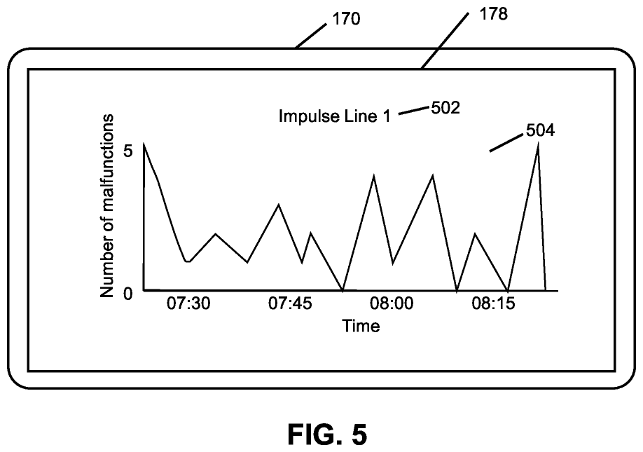

The alert may be specific to malfunctions associated with the first impulse line 122. For example, the alert may indicate a total number of malfunctions associated with the first impulse line 122 that have been detected. An example of an alert that is specific to a particular impulse line is shown in FIG. 5.

FIG. 5 shows an example of an alert displayed on the user interface 178 of the user device 170. The alert comprises text 502 (“Impulse Line 1”) which indicates that the alert is for the first impulse line 122. The alert also comprises a graph 504 which indicates the number of malfunctions associated with the first impulse line 122 in the time window 07:15-08:30.

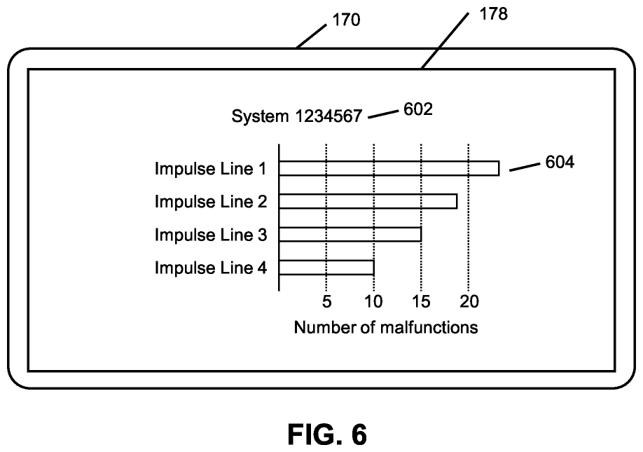

The alert may include information regarding malfunctions detected at more than one impulse line. An example of this is shown in FIG. 6.

FIG. 6 shows an example of another alert displayed on the user interface 178 of the user device 170. The alert comprises text 602 (“System 123567”) which indicates that the malfunctions are associated with impulse lines operatively connected to the system identified by the identifier 1234567. In this example, the system comprises four impulse lines. The alert also comprises a bar chart 604, in which each bar is associated with a respective impulse line in the four impulse lines (“Impulse Line 1”, “Impulse Line 2”, “Impulse Line 3”, “Impulse Line 4”) in a system. The bar for a particular impulse line indicates the number of malfunctions associated with the impulse line that have been detected. As illustrated, more than 20 malfunctions associated with the first impulse line (“Impulse Line 1”) have been detected, whilst only 10 malfunctions associated with the fourth impulse line (“Impulse Line 4”) have been detected.

Alerts comprising malfunction information for a plurality of impulse lines in a system may be particularly useful and they may allow a user (e.g. a human operator) to quickly identify where maintenance is most urgently needed in the system.

It will be appreciated that the alerts illustrated in FIGS. 5 and 6 are shown by way of example only. In general, the alerts may be output (e.g. displayed) in any suitable way.

Causing the alert may comprise outputting the alert at a user interface. The computing device 160 may comprise a user interface and output the alert at its user interface, for example. The computing device 160 may, for example, display the alert at a display associated with the computing device 160.

Causing the alert may, additionally or alternatively, comprise transmitting an indication of the detection to another apparatus to cause the other apparatus to output the alert at a user interface (e.g. the user interface of the other apparatus). The indication may be comprised in an instruction to output the alert, for example. In an example, the computing device 160 may cause the alert by transmitting, to the user device 170 (e.g. via the network 150), an indication that a malfunction associated with the first impulse line 122 has been detected. The user device 170 may, based on the received indication, output an alert at the user interface 178 of the user device 170. For example, the user device may display the alert on a display screen associated with the user device 170 (e.g. as shown in FIGS. 5 and 6).

Other Actions that May be Performed Responsive to Detecting a Malfunction

In some examples of the methods 200, 300 and 400, the computing device 160 may perform one or more other actions (e.g. other than causing an alert) in response to detecting an alert. The one or more other actions may be performed in addition to, or instead of, causing the alert.

In some examples, the computing device 160 may, for example, cause maintenance to be scheduled for the first impulse line 122 (e.g. that is, for the impulse line associated with the malfunction). The computing device 160 may, for example, transmit a request to a maintenance system, the request indication that maintenance is to be performed on the first impulse line 122.

The computing device 160 may cause an environmental control of the system 110 to be adjusted. The computing device 160 may adjust the environmental control directly or may instruct another apparatus to adjust the environment control of the system 110. As mentioned above, a malfunction associated with impulse lines that often occurs is freezing of the impulse line. This can be remedied by heating the impulse line. Thus, for example, the computing device 160 may actuate (e.g. turn on) a heater associated with the first impulse line 122 responsive to detecting the malfunction associated with the first impulse line 122. The heater may be attached to or positioned near to the first impulse line 122, for example.

In some examples, the computing device 160 may change the operation of the system 110 responsive to detecting the malfunction associated with the first impulse line 122. The computing device 160 may, for example, cause the isolation on the first impulse line 122 to be checked. The computing device 160 may cause the electrical heat tracing (EHT) of the first impulse line 122 to be increased. The computing device 160 may cause blowing down of the first impulse line 122. The computing device 160 may, for example, stop (e.g. pause) operation of the system 110. Stopping operation of the system 110 may involve preventing material from entering the system 110. Stopping operation of the system 110 may involve emptying material from the system 110 (e.g. by allowing existing material to leave the system 110 and preventing new material from entering the system 110). Stopping operation of the system 110 may comprise stopping operation of one or more processing apparatus (e.g. apparatus for processing material) in the system 110. Malfunctions associated with impulse lines can risk rupturing of impulse lines, material leakage and threats to personnel safety. As such, stopping operation of the system 110 responsive to a malfunction being detected may reduce the risk of some or all of these consequences from occurring.

The computing device 160 may perform any combination of the above-mentioned actions in response to detecting the malfunction. In some examples, the computing device 160 may only perform the one or more other actions when a threshold number of malfunctions have been detected. For example, the computing device 160 may cause the maintenance to be scheduled for the first impulse line 122 responsive to detecting that 100 malfunctions have occurred at the first impulse line 122.

Detecting Malfunctions Associated with Multiple Impulse Lines

Methods for detecting a malfunction associated with an impulse line have been described. Although the methods have been described in respect of detecting a malfunction associated with the first impulse line 122, it will be appreciated that the methods may be used to detect a malfunction associated with at least one of the first impulse line 122 and the second impulse line 132.

In some examples, the arrangement 100 may be provided with more than two impulse lines for monitoring properties of the contents of the system 110. The arrangement 100 may comprise different impulse lines for measuring different properties at different points in the system and/or the same property at different points in the system.

In general, the arrangement 100 may be provided with one or more groups of impulse line devices. Each group may comprise at least a respective first impulse line device (e.g. which may operate in accordance with the first impulse line device 120) and a respective second impulse line device (e.g. which may operate in accordance with the second impulse line device 130). Any of the methods 200, 300 and 400 may be performed in respect of each group of impulse line devices to detect whether a malfunction associated with at least one of the impulse line devices in the group has occurred. In some examples, the group may comprise two impulse devices (e.g. a pair of impulse devices). In other examples, the group may comprise more than two impulse devices. As such, the methods 200, 300, 400 described above may be adapted for more than two impulse devices.

It will be appreciated that each of the methods 200, 300 and 400 may be more or less appropriate for a particular group of impulse line devices, depending on the impulse line devices (e.g. whether they provide redundancy for one another), the training data available (if any), etc.

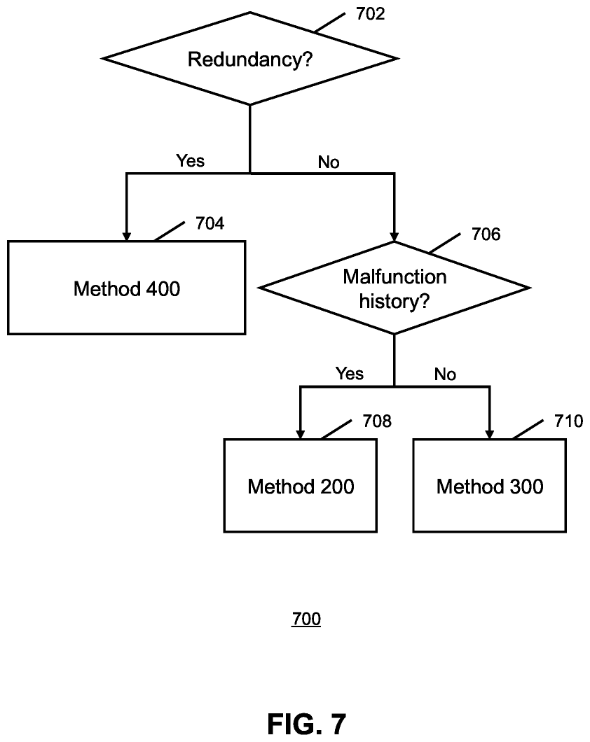

FIG. 7 illustrates a flowchart of a method 700 performed by the computing device 160 for determining which method to use to detect a malfunction associated with the first impulse line 122.

The method 700 is described with respect to the first impulse line 122 and the second impulse line 132, but it will be appreciated that the method 700 may be used to determine which method to use to detect a malfunction associated with any impulse line in a group (e.g. a pair) of impulse lines.

In step 702, the computing device 160 may determine whether the first impulse line 122 and the second impulse line 132 provide redundancy for one another. As described above, That is, two impulse lines may be redundant when they are connected to the system 110 in such a manner (e.g. at a particular point and/or in a particular configuration) such that measurements performed the impulse lines may be expected to be the same (e.g. exactly the same or within a tolerance).

In response to determining that the first impulse line 122 and the second impulse line 132 provide redundancy for one another, the computing device 160 may determine, in step 704, that the method 400 is to be used to detect a malfunction associated with the first impulse line 122. The method 400 may be particularly appropriate for pairs of impulse lines that provide redundancy for one another. This may arise when, for example, one of the impulse lines is provided as part of a control mechanism for the system 110 and the other of the impulse lines is provided as part of a safety mechanism for the system 110.

In response to determining that the first impulse line 122 and the second impulse line 132 do not provide redundancy for one another, the method 700 may proceed to step 706. In step 706, the computing device 160 may determine whether a malfunction history is available for the first impulse line 122. That is, the computing device 160 may determine whether measurements performed on the contents of the first impulse line 122 are available, in which the measurements have been performed during a time period in which it is known that a malfunction associated with the first impulse line 122 occurred. The computing device 160 may, for example, send a request to the database 140 for such measurements, for example.

In response to determining that a malfunction history for the first impulse line 122 is available, the computing device 160 may determine, in step 708, that the method 200 is to be used to detect a malfunction associated with the first impulse line 122. The method 200 may detect malfunctions associated with an impulse line with increased accuracy when the model using in step 206 has been developed using training data that is labelled with at least one label indicating that a malfunction has occurred (e.g. when the model has been developed using supervised machine-learning). That is, the method 200 may be particularly effective for impulse lines that have a known history of malfunction.

In response to determining that a malfunction history for the first impulse line 122 is not available, the computing device 160 may determine, in step 710, that the method 300 is to be used to detect a malfunction associated with the first impulse line 122. As described above, the method 300 may involve using a model developed using an unsupervised machine-learning process. As such, the method 300 may still be implemented (and may still achieve a high accuracy) even when measurements performed on contents of the first impulse line 122 during a known malfunction associated with the first impulse line are not available.

In the above description, the steps of methods may be described in a particular order. However, the disclosure is not limited as such and thus, in some examples, the order of the steps of the methods described herein may be varied. For example, step 204 may be performed before, after, or during (e.g. in parallel with) step 202 in the method 200. In another example, step 402 may be performed before, after or during step 404 in the method 400.

In some examples, one or more steps in the methods described herein may be omitted. For example, any of steps 210, 312 and 410 may be omitted from the methods 200, 300 and 400 respectively.

In the above description, the methods 200, 300, 400 and 700 are described as being performed by the computing device 160. However, it will be appreciated that the disclosure is not limited as such and, in general, any of the methods 200, 300, 400 and 700 may be performed by any suitable apparatus or group of apparatus. The apparatus may be configured to perform any of the methods 200, 300, 400 and 700. In some examples, one or more of the methods 200, 300, 400 and 700 may be performed by the database 140. In some examples, one or more of the methods 200, 300, 400 and 700 may be performed by the first impulse line device 120 or the second impulse line device 130. In some examples, one or more of the methods 200, 300, 400 and 700 may be performed by the user device 170. In some examples, one or more of the methods 200, 300, 400 and 700 may be performed by (e.g. distributed over) more than one apparatus (e.g. one or more of the apparatus in the arrangement 100).

The expressions “at least one of X and Y”, “at least one of X or Y”, “one or more of X and Y” and “one or more of X or Y” as used in the present disclosure may be interchangeable with the expression “X and/or Y”. These expressions may refer to a list in which X or Y may be selected or both X and Y may be selected. Similarly, “at least one of X, Y, and Z”, “at least one of X, Y or Z”, “one or more of X, Y and Z” and “one or more of X or Y” may be interchangeable with “X and/or Y and/or Z” or “X, Y, and/or Z”. These expressions may refer to a list in which any of the following may be selected: X or Y or Z, or both X and Y, or both X and Z, or both Y and Z, or all of X, Y and Z. The meaning may apply for longer lists in the same format.

1. A method for detecting a malfunction associated with a first impulse line operatively connected to a system, the method comprising:
obtaining a first correlation between first measurements and second measurements, the first measurements performed on contents of the first impulse line in a first time window, the second measurements performed on contents of a second impulse line in a second time window that overlaps the first time window, the second impulse line being operatively connected to the system,
obtaining a first amount of variation of the first measurements in the first time window;
inputting the first amount of variation and the first correlation to a model to detect whether a malfunction associated with the first impulse line has occurred, wherein the model has been developed using a machine-learning process; and
responsive to detecting that the malfunction has occurred at the first impulse line, causing an alert indicating that the malfunction has been detected.

2. The method of claim 1, wherein the model has been developed by inputting, to the machine-learning process:
a second amount of variation of third measurements in a third time window, the third measurements having been performed on contents of the first impulse line; and
a second correlation between the third measurements and fourth measurements in a fourth time window that overlaps with the third time window, the fourth measurements having been performed on contents of the second impulse line.

3. The method of claim 2, wherein the model has been developed by inputting, to the machine-learning process:
a label associated with the second amount of variation and the second correlation, the label indicating whether a malfunction associated with the first impulse line occurred in the third time window.

4. The method of claim 3, wherein the label indicated that the malfunction associated with the first impulse line occurred in the third time window.

5. The method of claim 1, wherein the first time window is a sliding time window.

6. The method of claim 1, wherein the second time window is a sliding time window.

7. The method of claim 1, wherein the first time window has a duration of between 60-100 minutes.

8. The method of claim 1, wherein the second time window has a duration of between 60-100 minutes.

9. The method of claim 1, wherein the first and second time window are the same.

10. The method of claim 1, wherein the method further comprises:
receiving the first measurements from a first transmitter associated with the first impulse line.

11. The method of claim 1, wherein the method further comprises:
determining the first amount of variation of the first measurements.

12. The method of claim 1, wherein the method further comprises receiving the second measurements from a second transmitter associated with the second impulse line.

13. The method of claim 1, wherein obtaining the first correlation between the first measurements and the second measurements comprises:
determining the first correlation based on the first measurements and the second measurements.

14. The method of claim 1, wherein the first amount of variation of the first measurements in the first time window comprises a standard deviation of the first measurements in the first time window.

15. The method of claim 1, wherein the first measurements comprise measurements of a first property performed on the contents of the first impulse line and the second measurements comprise measurements of a second property performed on the contents of the second impulse line, wherein the first property and the second property are different.

16. A method for detecting a malfunction associated with a first impulse line operatively connected to a system, the method comprising:
obtaining a predicted measurement for the first impulse line at a first time, wherein the predicted measurement is based on a first measurement and a second measurement, the first measurement having been performed on contents of the first impulse line at a second time before the first time, the second measurement having been performed on contents of a second impulse line, the second impulse line being operatively connected to the system;
comparing the predicted measurement to a third measurement performed using the first impulse line at the first time to detect whether a malfunction associated with the first impulse line has occurred; and
responsive to detecting that the malfunction has occurred at the first impulse line, causing an alert indicating that the malfunction has been detected.

17. The method of claim 16, wherein the second measurement is performed on contents of the second impulse line at the first time.

18. The method of claim 16, wherein obtaining the predicted measurement comprises:
receiving the first measurement;
receiving the second measurement; and
inputting the first and second measurements to a model to obtain the predicted measurement for the first impulse line at the first time.

19. The method of claim 18, wherein the model has been developed using a machine-learning process.

20. The method of claim 19, wherein the model has been developed by inputting, to the machine-learning process:
fourth measurements performed on contents of the first impulse line; and
fifth measurements performed on contents of the second impulse line.

21. The method of claim 20, wherein:
the fourth measurements are indicative of an operational range of the first impulse line; and
the fifth measurements are indicative of an operational range of the first impulse line.

22. The method of claim 16, wherein comparing the predicted measurement to the third measurement to detect whether a malfunction associated with the first impulse line has occurred comprises:
responsive to a difference between the predicted measurement and the third measurement satisfying a threshold, detecting that the malfunction has occurred.

23. The method of claim 16, wherein the first measurement comprises a measurement of a first property performed on the contents of the first impulse line and the second measurement comprises a measurement of a second property performed on the contents of the second impulse line, wherein the first property and the second property are different.

24. The method of claim 15, wherein the first property comprises pressure.

25. The method of claim 15, wherein the first property comprises level.

26. The method of claim 15, wherein the first property comprises flow.

27. The method of claim 15, wherein the second property comprises pressure.

28. The method of claim 15, wherein the second property comprises level.

29. The method of claim 15, wherein the second property comprises flow.

30. A method for detecting a malfunction associated with a first impulse line operatively connected to a system, the method comprising:
obtaining a first amount of variation in first measurements of a property of contents of the first impulse line in a first time window;
obtaining a second amount of variation in second measurements of the property of contents of a second impulse line in a second time window, wherein the second impulse line is operatively connected to the system to provide redundancy for the first impulse line, wherein the first and second time window overlap;
comparing a difference between the first amount of variation and the second amount of variation to a threshold to detect whether a malfunction associated with the first impulse line has occurred; and
responsive to detecting that the malfunction associated with the first impulse line has occurred, causing an alert indicating that the malfunction has been detected.

31. The method of claim 30, wherein the first amount of variation comprises a standard deviation of the first measurements.

32. The method of claim 30, wherein the second amount of variation comprises a standard deviation of the second measurements.

33. The method of claim 30, wherein the first and second time window are the same.

34. The method of claim 30, wherein the first time window is a sliding time window.

35. The method of claim 30, wherein the second time window is a sliding time window.

36. The method of claim 30, wherein the property comprises pressure.

37. The method of claim 30, wherein the property comprises level.

38. The method of claim 30, wherein the property comprises flow.

39. The method of claim 1, wherein the malfunction comprises clogging of the first impulse line.

40. The method of claim 39, wherein the malfunction comprises clogging of the first impulse line due to freezing of the first impulse line.

41. The method of claim 1, wherein causing the alert causes the alert to be output at a user interface associated with a controller of the system.

42. A processor-readable storage medium storing processor-executable instructions which, when executed by at least one processor of an apparatus, cause the apparatus to perform the method of claim 1.

43. An apparatus configured to perform the method of claim 1.

44. An apparatus for detecting a malfunction associated with first impulse line operatively connected to a system, the apparatus comprising
at least one processor; and
a non-transitory computer-readable storage medium storing instructions which, when executed by the at least one processor, cause the apparatus to:
obtain a first correlation between first measurements and second measurements, the first measurements performed on contents of the first impulse line in a first time window, the second measurements performed on contents of a second impulse line in a second time window that overlaps the first time window, the second impulse line being operatively connected to the system,
obtain a first amount of variation of the first measurements in the first time window;
input the first amount of variation and the first correlation to a model to detect whether a malfunction associated with the first impulse line has occurred, wherein the model has been developed using a machine-learning process; and
responsive to detecting that the malfunction has occurred at the first impulse line, cause an alert indicating that the malfunction has been detected.

45. The apparatus of claim 44, wherein the model has been developed by inputting, to the machine-learning process:
a second amount of variation of third measurements in a third time window, the third measurements having been performed on contents of the first impulse line; and
a second correlation between the third measurements and fourth measurements in a fourth time window that overlaps with the third time window, the fourth measurements having been performed on contents of the second impulse line.

46. The apparatus of claim 45, wherein the model has been developed by inputting, to the machine-learning process:
a label associated with the second amount of variation and the second correlation, the label indicating whether a malfunction associated with the first impulse line has occurred in the third time window.

47. The apparatus of claim 46, wherein the label indicated that the malfunction associated with the first impulse line occurred in the third time window.

48. The apparatus of claim 44, wherein the first time window is a sliding time window.

49. The apparatus of claim 44, wherein the second time window is a sliding time window.

50. The apparatus of claim 44, wherein the first time window has a duration of between 60-100 minutes.

51. The apparatus of claim 44, wherein the second time window has a duration of between 60-100 minutes.

52. The apparatus of claim 44, wherein the first time window and the second time window are the same.

53. The apparatus of claim 44, wherein the apparatus is further caused to:
receive the first measurements from a first transmitter associated with the first impulse line.

54. The apparatus of claim 44, wherein the apparatus is further caused to:
determine the first amount of variation of the first measurements.

55. The apparatus of claim 44, wherein the apparatus is further caused to:
receive the second measurements from a second transmitter associated with the second impulse line.

56. The apparatus of claim 44, wherein the apparatus is caused to obtain the first correlation between the first measurements and the second measurements by:
determining the first correlation based on the first measurements and the second measurements.

57. The apparatus of claim 44, wherein the first amount of variation of the first measurements in the first time window comprises a standard deviation of the first measurements in the first time window.

58. The apparatus of claim 44, wherein the first measurements comprise measurements of a first property performed on the contents of the first impulse line and the second measurements comprise measurements of a second property performed on the contents of the second impulse line, wherein the first property and the second property are different.

59. An apparatus for detecting a malfunction associated with first impulse line operatively connected to a system, the apparatus comprising at least one processor; and
a non-transitory computer-readable storage medium storing instructions which, when executed by the at least one processor, cause the apparatus to:
obtain a predicted measurement for the first impulse line at a first time, wherein the predicted measurement is based on a first measurement and a second measurement, the first measurement having been performed on contents of the first impulse line at a second time before the first time, the second measurement having been performed on contents of a second impulse line, the second impulse line being operatively connected to the system;
compare the predicted measurement to a third measurement performed using the first impulse line at the first time to detect whether a malfunction associated with the first impulse line has occurred; and
responsive to detecting that the malfunction has occurred at the first impulse line, cause an alert indicating that the malfunction has been detected.

60. The apparatus of claim 59, wherein the second measurement is performed on contents of the second impulse line at the first time.

61. The apparatus of claim 59, wherein the apparatus is caused to obtain the predicted measurement by:
receiving the first measurement;
receiving the second measurement; and
inputting the first and second measurements to a model to obtain the predicted measurement for the first impulse line at the first time.

62. The apparatus of claim 61, wherein the model has been developed using a machine-learning process.

63. The apparatus of claim 62, wherein the model has been developed by inputting, to the machine-learning process:
fourth measurements performed on contents of the first impulse line; and
fifth measurements performed on contents of the second impulse line.

64. The apparatus of claim 63, wherein:
the fourth measurements are indicative of an operational range of the first impulse line; and
the fifth measurements are indicative of an operational range of the first impulse line.

65. The apparatus of claim 59, wherein the apparatus is caused to compare the predicted measurement to the third measurement to detect whether a malfunction associated with the first impulse line has occurred by:
responsive to a difference between the predicted measurement and the third measurement satisfying a threshold, detecting that the malfunction has occurred.

66. The apparatus of claim 59, wherein the first measurement comprises a measurement of a first property performed on the contents of the first impulse line and the second measurement comprises a measurement of a second property performed on the contents of the second impulse line, wherein the first property and the second property are different.

67. The apparatus of claim 58, wherein the first property comprises pressure.

68. The apparatus of claim 58, wherein the first property comprises level.

69. The apparatus of claim 58, wherein the first property comprises flow.

70. The apparatus of claim 58, wherein the second property comprises pressure.

71. The apparatus of claim 58, wherein the second property comprises level.

72. The apparatus of claim 58, wherein the second property comprises flow.

73. An apparatus for detecting a malfunction associated with first impulse line operatively connected to a system, the apparatus comprising
at least one processor; and
a non-transitory computer-readable storage medium storing instructions which, when executed by the at least one processor, cause the apparatus to:
obtain a first amount of variation in first measurements of a property of contents of the first impulse line in a first time window;
obtain a second amount of variation in second measurements of the property of contents of a second impulse line in a second time window, wherein the second impulse line is operatively connected to the system to provide redundancy for the first impulse line, wherein the first and second time window overlap;
compare a difference between the first amount of variation and the second amount of variation to a threshold to detect whether a malfunction associated with the first impulse line has occurred; and
responsive to detecting that the malfunction associated with the first impulse line has occurred, cause an alert indicating that the malfunction has been detected.

74. The apparatus of claim 73, wherein the first amount of variation comprises a standard deviation of the first measurements.

75. The apparatus of claim 73, wherein the second amount of variation comprises a standard deviation of the second measurements.

76. The apparatus of claim 73, wherein the first and second time window are the same.

77. The apparatus of claim 73, wherein the first time window is a sliding time window.

78. The method of claim 73, wherein the second time window is a sliding time window.

79. The apparatus of claim 73, wherein the property comprises pressure.

80. The apparatus of claim 73, wherein the property comprises level.

81. The apparatus of claim 73, wherein the property comprises flow.

82. The apparatus of claim 44, wherein the malfunction comprises clogging of the first impulse line.

83. The apparatus of claim 44, wherein the malfunction comprises clogging of the first impulse line due to freezing of the first impulse line.

84. The apparatus of claim 44, wherein the apparatus is caused to cause the alert by causing the alert to be output at a user interface associated with a controller of the system.
